(19) United States
(12) Patent Application Publication
(10) Pub. No.: US 2015/0356468 A1
(43) Pub. Date: Dec. 10, 2015

(54) MOBILE CHAT SYSTEMS FOR REAL TIME POLLING, RATING AND RSVP'ING

(71) Applicant: RE:GROUP'D MEDIA INC., Harrison, NY (US)

(72) Inventor: Lindsey CUMMINS, Harrison, NY (US)

(21) Appl. No.: 14/730,046

(22) Filed: Jun. 3, 2015

Related U.S. Application Data
(60) Provisional application No. 62/008,421, filed on Jun. 5, 2014.
(60) Provisional application No. 62/130,443, filed on Mar. 9, 2015.
(60) Provisional application No. 62/143,699, filed on Apr. 6, 2015.

(51) Int. Cl. G06Q 10/02; G06Q 50/00; H04L 12/58

(52) U.S. Cl. CPC G06Q 10/02; H04L 51/046; G06Q 50/01

(57) ABSTRACT

The present disclosure provides methods for real time polling, rating, or requesting reservations to events, comprising receiving, on a mobile electronic device of a first user, a query from an electronic device of a second user. The query can be a polling query, rating query, or a request for a reservation to a given event. Next, the query is presented on a user interface (UI) of a chat application on the mobile electronic device of the first user. A response to the query is then received from the first user on the UI, and transmitted from the mobile electronic device of the first user to the electronic device of the second user. The response is then displayed on a user interface of the electronic device of the second user.

### CROSS-REFERENCE

This application claims priority to U.S. Provisional Patent Application Ser. No. 62/008,421, filed Jun. 5, 2014; U.S. Provisional Patent Application Ser. No. 62/130,443, filed Mar. 9, 2015; and U.S. Provisional Patent Application Ser. No. 62/143,699, filed Apr. 6, 2015, the disclosures of which are each entirely incorporated herein by reference.

### BACKGROUND

Online chat is typically any kind of communication over the Internet that offers a real-time transmission of electronic messages (e.g., text messages or instant messages) from a sender user to a receiver user. Chat messages may be substantially short in order to enable other participants to respond quickly. Chatting may approach the level of spoken conversation and may thus be distinguishable from other text-based modes of communication, such as Internet forums and electronic mail (“email”). Online chat may address point-to-point communications as well as multicast communications from one sender to many receivers and voice and video chat, or may be a feature of a web conferencing service.

The use of mobile devices in various types of mobile consumer transactions and commerce related communications is becoming more common and more complex. Mobile devices, such as cell phones, smart phones, and Personal Digital Assistants (PDAs), are typically used to facilitate chatting sessions between uses.

### SUMMARY

While there are chatting systems and methods present available, recognized herein are limitations associated with such systems and methods. Current chat systems may not enable a user to gauge interest in a given topic, such as a topic of potential interest to one or more friends of the user, or solicit a response to a given question. If a user is interested in gauging the interest of other users through a chat session, the user may provide a question and await a response, but this process is typically time consuming as the user is required to input a question and await a response. Recipients of the question may not be compelled to provide a quick answer given that it takes time to input a response. Recognized herein is thus the need for chat systems for real time communication between users in a manner that enables one user to gauge interest in a given topic or solicit a response.

The present disclosure provides systems and methods for real time polling, rating (or ranking), responding to event requests and soliciting responses to questions. Such systems and methods advantageously enable users to quickly obtain responses to questions and to gauge user interest in a given topic in an intuitive and efficient manner. Systems and methods of the present disclosure can substantially improve the manner in which users gauge interest with respect to a given topic or solicit responses from one another in a mobile setting, such as using mobile electronic devices.

An aspect of the present disclosure provides a method for real time polling, rating, or requesting reservations to events, comprising receiving, on a mobile electronic device of a first user, a query from an electronic device of a second user. The query can be a polling query, rating query, or a request for a reservation to a given event. Next, the query is presented on a user interface (UI) of a chat application on the mobile electronic device of the first user. A response to the query is then received on the UI from the first user. The response is then transmitted from the mobile electronic device of the first user to the electronic device of the second user. The response is then displayed on a user interface of the electronic device of the second user.

Queries can be presented on electronic devices of multiple users in real time. Responses to the queries can be viewed on multiple electronic devices of multiple users in real time.

Another aspect of the present disclosure provides a method for real time polling, rating, or requesting reservations to events, comprising directing a query from an electronic device of a user to a mobile electronic device of each of one or more other users. The query can be a polling query, rating query, or a request for a reservation to a given event. Next, one or more responses to the query are received from at least a subset of the one or more other users. A report is then generated from the one or more responses on the electronic device of the user. The report is then displayed on a user interface of the electronic device of the user, in some cases in real time.

Another aspect of the present disclosure provides a computer readable medium (e.g., memory) comprising machine-executable code that, upon execution by one or more computer processors, implements any of the methods above or elsewhere herein.

Another aspect of the present disclosure provides a system comprising one or more computer processors and a computer readable medium (e.g., memory). The computer readable medium comprises machine-executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a method for facilitating a query in a chat session;

FIG. 2 shows an electronic display comprising a user interface that includes a chat window (or panel) that displays a chat session between a first user and a second user;

FIG. 3 shows a user interface that includes a chat window that displays a chat between a first user and a second user;

FIG. 4 shows a user interface that includes a window that includes a poll query from a user;

FIG. 5 shows a user interface that includes a window that includes a rating query from a user;

FIG. 6 shows a user interface that includes a window that includes a reservation query from a user;

FIG. 7 shows a computer system that is programmed or otherwise configured to implemented methods and systems of the present disclosure;

FIGS. 8-23 schematically illustrate a chat application that enables users to post queries and receive responses to the queries;

FIGS. 24-26 schematically illustrate a verification application that enables users to signup and login to a chat application;

FIGS. 27-30 show screen shots that illustrate aspects of a chat application;

FIGS. 31-37 show screen shots that illustrate group aspects of a chat application;

FIGS. 38-41 show screen shots that illustrate polling aspects of a chat application;

FIGS. 42-45 show screen shots that illustrate rating aspects of a chat application;

FIGS. 46-48 show screen shots that illustrate RSVP aspects of a chat application; and

FIGS. 49-52 show screen shots that illustrate Yes/No aspects of a chat application;

FIG. 53 shows a screen shot that illustrates entities that a user is following; and

FIGS. 54-56 show screen shots that illustrate interactions between a user and a curator.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “chat,” as used herein, generally refers to a dialogue between a user and one or more other users. A chat can be between the user and another user, or between the user and multiple other users, such as a group chat. A chat can be facilitated by a computer system and implemented, for example, by way of mobile (or portable) electronic devices, such as mobile telephones, smart phones, tablet or slate personal computers (PC's), or laptop PC's.

The term “rating,” as used herein, generally refers to a position in a scale of status, or the action or process of giving a specified rank or place within a grading system.

The term “polling,” as used herein, generally refers to the process of voting or casting a selection of an item among multiple items. In some examples, the term “polling” may not refer to “Yes” and “No” responses.

The term “RSVP” (répondez s'il vous plaît), as used herein, generally refers to a request for a reservation or reply.

The term “query,” as used herein, generally refers to a request for a response from a user. A query can include a question. A query can include a polling request, rating request, or a reservation request.

### Methods for Presenting Queries

An aspect of the present disclosure provides methods for presenting queries to users and receiving responses to the queries. The queries can be real time polling, rating, or RSVP′ing (e.g., requesting reservations to events). These methods can be implemented using computer systems of the present disclosure, as describe elsewhere herein.

A method for presenting a query and receiving a response to the query comprises receiving the query from an electronic device of a first user. The electronic device of the first user can be a mobile (or portable) electronic device. The query can be received on a server or an electronic device of a second user, such as a mobile (or portable) electronic device. The query can be received on electronic devices of other users, such as a third user, fourth user, fifth user and sixth user. Next, the query can be presented on a user interface (UI) of a chat application on the electronic device of the second user. The query can be a polling query, rating query, or a request for a reservation to a given event. Next, a response to the query is received by the mobile electronic device from the second user and presented on the UI. The response is then transmitted to the electronic device of the first user and subsequently displayed on a user interface of the electronic device of the first user.

The response can be transmitted from the electronic device of the second user to the electronic device of the first user directly or through another computer system, such as a computer server. In some example, the computer server is the intermediary between electronic devices of user.

The UI can be a graphical user interface (GUI) or a web-based user interface. The GUI can include textual and/or graphical information for enabling a user to view the query and respond to the query.

In some cases, the query is displayed in the chat application. The chat application can display a chat between the first user and the second user, and in some cases one or more other users. The chat application can display queries and responses to the queries among multiple users in real time.

The response can be displayed on a user interface of a chat application executed on the electronic device of the first user. The chat application can be configured to display a chat between the first user and the second user and/or one or more other users, such as, for example, in the context of a group chat comprising multiple users, such as at least 2, 3, 4, 5, 6, 7, 8, 9, 10, 20, 30, 40, or 50 users.

In some cases, if the query is a request for a reservation to a given event, the event can be a social event, recreational event, educational event, or work event. The event can be, for example, a dinner party, a sports game, a show, or other social or entertainment event.

The query can be received in the form of an electronic message. In some cases, the electronic message is a short message service (SMS) text message or a multimedia messaging service (MMS) text message. As an alternative, the electronic message is an electronic mail (email) or an instant message.

Another aspect of the present disclosure provides a method for real time polling, rating, or requesting reservations to events, comprising first directing a query from an electronic device of a user to a mobile electronic device of each of one or more other users. The query can be a polling query, rating query, or a request for a reservation to a given event. Next, one or more responses to the query are received from at least a subset of the one or more other users. A report is then generated from the one or more responses on the electronic device of the user. Next, the report is displayed on a UI of the electronic device of the user. The report can be displayed on a UI of an electronic device of anyone that received the query, or anyone that can be authorized or permitted to view the report.

The report can be displayed in a chat application on the electronic device of the user. The report can be an electronic report that can be presented in various formats, such as, for example, a list format or a graphical format.

The chat application can include or display a chat between the user and at least some of the other users. For example, the query can be presented to the one or more other users while the user and the one or more other users are engaged in a chat. The user can be engaged in a chat with at least 1, 2, 3, 4, 5, 6, 7, 8, 9, 10, 20, 30, 40, or 50 other users.

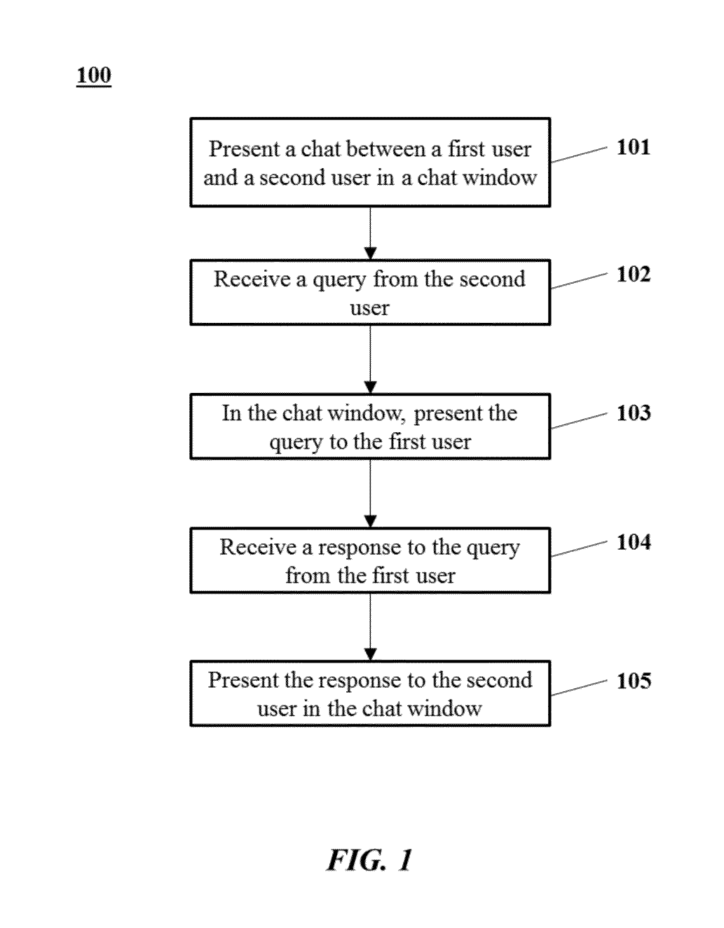

FIG. 1 shows a method 100 for facilitating a query in a chat session. The method can be facilitated by a computer system that is programmed or otherwise configured to facilitate a chat, present a query to users and receive responses to the query.

In a first operation 101, a chat between at least a first user and a second user is presented in a chat window of a user interface of a chat application. The chat application can be executed on an electronic device of each of the first and second users.

Next, in a second operation 102, a query is received from the second user. The query can be a general query (i.e., not directed to any particular user), or may be directed to select users, such as the first user or groups of users. The query can be directed to users selected by second user, or users that can be located in a given geographic area (e.g., Manhattan, N.Y.). The query can be a poll, rating, or reservation request.

Next, in a third operation 103, the query is presented to the first user in the chat window (or other window, such as a dedicated query window) of an electronic device of the first user. The query can be presented in a manner that is visually distinct from other information exchanged between users in the chat window as part of the chat session, such as text and/or images. For example, the query can be presented in a query panel that has a visually distinct background. The query can include one or more input fields to solicit a response from a user, such as radio buttons, drop-down menus, selectable lists, and/or text input fields.

Next, in a fourth operation 104, a response to the query is received from the first user. The response can be received by the electronic device of the first user and displayed in the chat window or dedicated query window.

Next, in a fifth operation 105, the response to the query is presented to the second user. The response can be displayed in the query window. In some examples, the response can be presented in the query panel. The response can be presented in a manner that is visually distinct from other information exchanged between users in the chat window as part of the chat session, such as text and/or images.

Multiple responses from various users can be displayed in the query window. In a rating or polling scenario, this can enable the users to view the results of a rating or poll across the various users. In a request for reservation, this can enable the users to view a list or compilation of users that have indicated a willingness to attend a given event.

### User Interfaces for Presenting Queries

The present disclosure provides user interfaces for facilitating the display of queries to users, such as real time polling, rating, or RSVP'ing (e.g., requesting reservations to events). Such user interfaces can be implemented using computer systems of the present disclosure, as describe elsewhere herein. User interfaces provided herein can be displayed on electronic displays of electronic devices of users (e.g., mobile electronic devices), which can include passive displays or active displays. Examples of displays include monitors and touchscreens, which can permit user interaction using one or more fingers of the user.

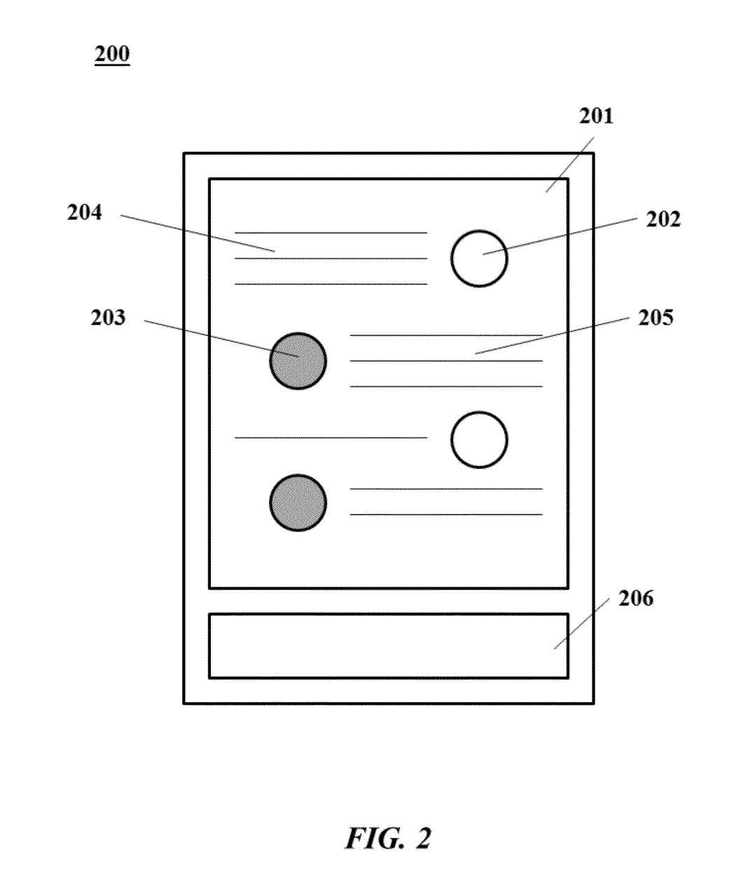

FIG. 2 shows an electronic display comprising a user interface 200 that includes a chat window (or panel) 201 displaying a chat session between a first user 202 and a second user 203. The user interface 200 can be part of a chat application that is programmed or otherwise configured to provide the chat session. The electronic display 200 can be part of an electronic device (e.g., mobile electronic device) of either the first user 202 or the second user 203. During the chat, the first user 202 presents text and/or images 204 for display to the second user 203, and the second user 203 presents text and/or images 205 for display to the first user 202. The first user 202 and second user 203 can exchange text and/or images with one another as part of a dialogue during the chat.

In chat window 201, the first user 202 and second user 203 can be graphically depicted by an image, such as an avatar or other visual representation (e.g., symbol, geometric shape, or picture) of each user. In the illustrated example, the first user 202 is represented by an open circle and the second user 203 is represented by a gray circle. Messages presented in chat window 201 may come in from a same side. Alternatively, messages presented in a chat window may come in from alternating sides.

The chat window 201 can display a chat among two or more users, such as at least 2, 3, 4, 5, 6, 7, 8, 9, 10, 20, 30, 40, or 50 users. The chat window 201 can display individual users sequentially, such as one after the other. Users can be displayed in a staggered arrangement.

The user interface 200 can also include a menu window (or panel) 206 that enables a user (e.g., the first user 202 or second user 203) to select or navigate between various features of the chat application. The menu window 206 can include one or more navigation links (e.g., icons) to enable navigation in the chat application. For example, the menu window 206 can include a group icon, query icon, chat icon, contacts icon and settings icon. The group icon can show the user which groups the user is a part of. The query icon can show the user which queries (e.g., real time polling, rating, or requesting reservations to events) the user has generated or responded to. The chat icon can show active and previous chats of the user. The contacts icon can show a contacts list of the user. The settings icon can enable the user to view and modify various settings of the application.

During use of the chat application, a user can elect post a query, such as real time polling, rating, or requesting a reservation to an event. The user may wish to solicit responses from a select group of users (e.g., work friends) or all users as part of a contact list of the user. The query can be displayed in a chat window of the user interface.

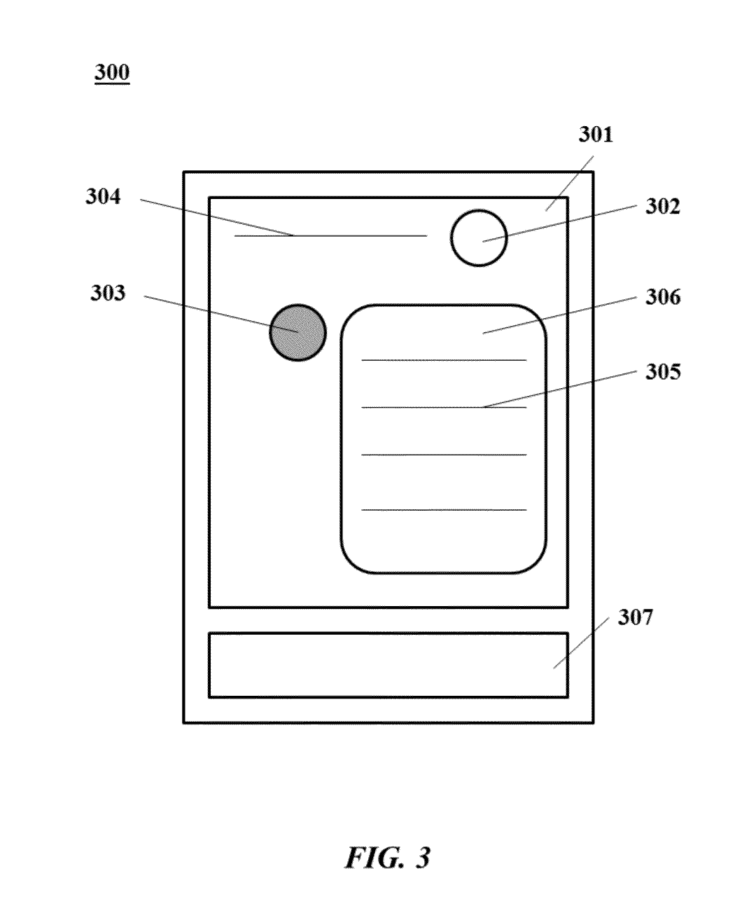

FIG. 3 shows a user interface 300 that includes a chat window 301 displaying a chat between a first user 302 and a second user 303. The chat window 301 can include a dialogue between at least 2, 3, 4, 5, 6, 7, 8, 9, 10, 20, 30, 40, or 50 users. The first user 302 presents text and/or images 304 to the second user 303. The second user 303 posts a query 305 in a query window 306. The query 305 can be a request for real time polling, rating, or reservation to an event.

The query can enable all or a subset of users in the chat window 301 to respond to the query, such as respond to the poll, provide a rating (or ranking) or make a reservation to the event. The query 305 can be accessible by all or a subset of users that are part of the chat displayed in the chat window 301. For example, the second user 303 can set the query 305 to be accessible by select users in the chat window 301. As another example, the second user 303 can set the query 305 to be accessible by all users in the chat window 301, or all users in a given geographic location. Such selection can be made using privacy options of the chat application. In some cases, if the query is sent to a group of users, all users in the group have the ability to respond to the query.

In some situations, responses are collected and results are displayed in real time. In some cases, the second user 303 can set a time limit within which responses to the query 305 must be received by users that are presented with the query 305. Such time limit can be, for example, at least about 30 seconds, 1 minute (min), 2 min, 3 min, 4 min, 5 min, 10 min, 20 min, 30 min, 1 hour, 2 hours, 3 hours, 4 hours, 5 hours, 6 hours, 12 hours, or 1 day. Upon the expiration of the time limit, user may not be able to respond to the query 305, but may be able to view responses to the query 305.

In some cases, the second user 303 can set a geographic location (“geolocation”) in which a user may respond to the query 305. For example, the second user 303 can elect to have users that are in Manhattan, N.Y. or San Francisco, Calif. respond to the query 305. In such a case, users in other geolocations may not be able to respond to the query 305. The geolocation of a given user can be determined using an electronic device of the user, such as using a global positioning system (GPS) or wireless triangulation.

The query window 306 can be rendered to be visually distinct than the text and/or images 304, which can help solicit user response(s) to the query. For example, the query window 306 can have a background that is darker or lighter than other windows in the chat window 301, or a shape that is different than other windows in the chat window 301. The query window 306 can be rendered to be animatable.

The query 305 can include graphical and/or textual information, which can be geared towards soliciting user response(s). In some cases, the query 305 can display user responses in real time or, in some cases, after a given period of time. For example, if the query 305 is a rating or polling, then the query window 306 can display responses to the rating or polling query in real time or after at 1, 2, 3, 4, 5 or more minutes.

The query window 306 can post the query 305 and provide details as to which user in the chat window 301 posted the query, and also provide additional details as to the query.

The user interface 300 can also include a menu window (or panel) 307 that enables a user (e.g., the first user 302 or second user 303) to select or navigate between various features of the chat application. For example, the menu window 307 can include one or more navigation links (e.g., icons) to enable navigation between various features of the chat application.

User interfaces of the present disclosure may present queries in line with chats between users, or present queries independently of chats between users. In some situations, chat windows present queries along with chats between users. As an alternative, chat windows can present queries in windows that do not include chats between users.

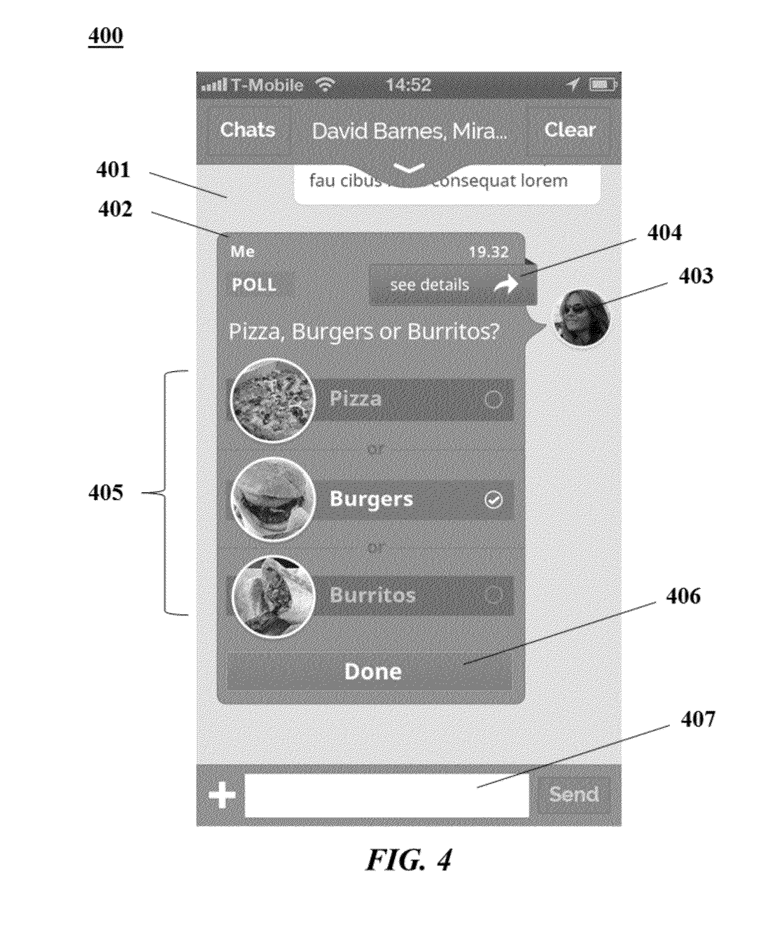

FIGS. 4-6 show examples user interfaces for presenting queries to users. Such user interfaces can be implemented using computer systems of the present disclosure, as describe elsewhere herein.

FIG. 4 shows a user interface 400 that includes a window 401 that includes a query 402 from a user 403. The query 402 in the illustrated example is a poll. The query 402 includes additional details, which may be accessed through a details button or link 404. The query 402 includes response options 405 (e.g., “Pizza,” “Burgers,” or “Burritos”) that are selected by the user 403. A user viewing the query 402 can respond to the query by electing one of the options 405, and submitting a response to the query 402 using a button or link 406. In a chat setting, the user can chat with the user 403 using the window 407 to input text, for example.

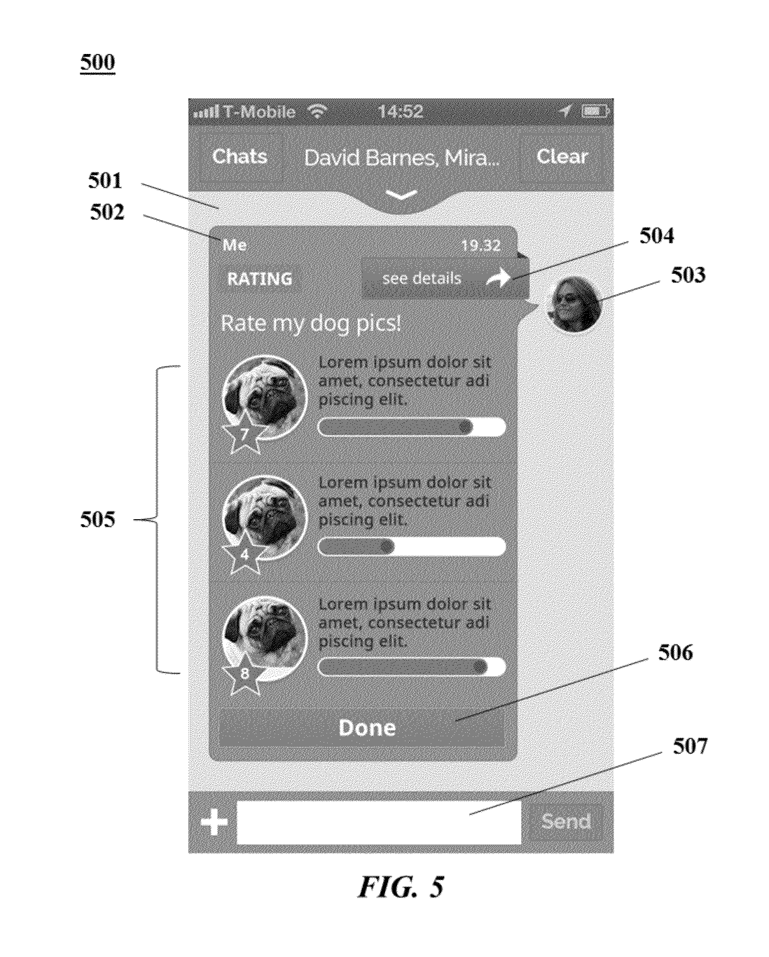

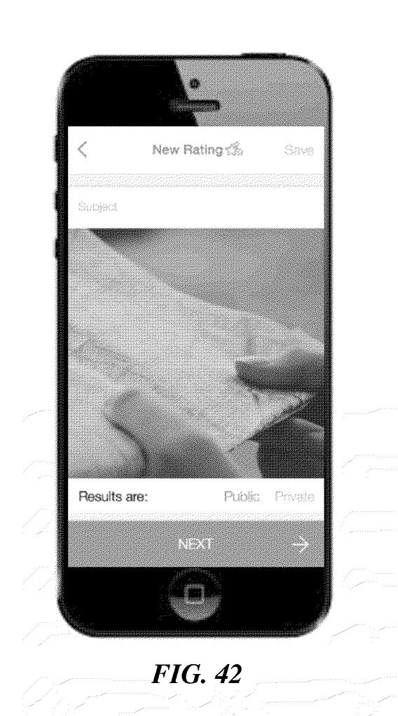

FIG. 5 shows a user interface 500 that includes a window 501 that includes a query 502 from a user 503. The query 502 in the illustrated example is a rating request. The query 502 includes additional details, which may be accessed through a details button or link 504. The query 502 includes items 505 (e.g., pictures) provided or selected by the user 503, with the option to rate each of the items 505. A user viewing the query 502 can rate (e.g., on a scale of 1-10) each of the items and submit the user's responses to the query 502 using a button or link 506. In a chat setting, the user can chat with the user 503 using the window 507 to input text, for example. In other examples, a rating may be used to rate one item alone. FIGS. 42-45 illustrate further examples of ratings.

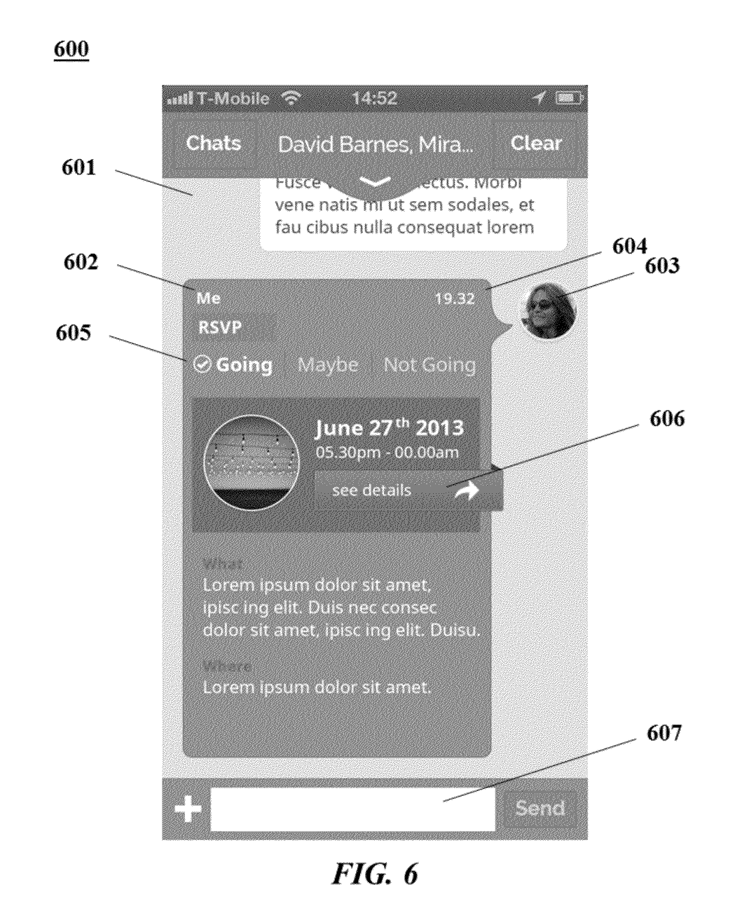

FIG. 6 shows a user interface 600 that includes a window 601 that include a query 602 from a user 603. The query 602 in the illustrated example is a request to make a reservation to a given event, which may be selected, hosted or presented by the user 603. The query 602 includes details of the event (e.g., location, date and time), which may be accessed through a details button or link 604. The query 602 includes options 605 for responding to the reservation request (e.g., “Going,” “Maybe,” or “Not Going”). A user viewing the query 602 can rate can select one of the options 605 (“Going,” as illustrated) and submit the user's response to the query 602 using a details button or link 606. In a chat setting, the user can chat with the user 603 using the window 607 to input text, for example. The user can view who else is attending the event. The user may be presented with the option to allow other individuals to invite people.

In some examples, the system can elect to request a reservation to an event. The user may be presented with a list of events, which can be collected or determined, for example, from an electronic calendar of the user. For example, the electronic calendar of the user includes the event entry “Go the dinner with friends.” The chat application can access the calendar and retrieve the event entry, and enable the user to request a reservation to the event entry in the chat application.

Windows for presenting queries may be dynamic or static. Such windows may be continuously, semi-continuously or periodically updated. For instance, windows for presenting queries can be changed or updated based on responses received from queries. For example, a poll query can be updated in real time to reflect responses to the poll. The responses can be separate from a chat session in the chat application. As an alternative, windows for presenting queries can be updated after a given period of time, such as, for example, after a period that is greater than or equal to about 10 seconds, 30 seconds, 1 minute, 5 minutes, 10 minutes, 20 minutes, 30 minutes, or 1 hour. For example, a window with a poll query can present the results of the poll after a period of 5 minutes.

### Computer Systems

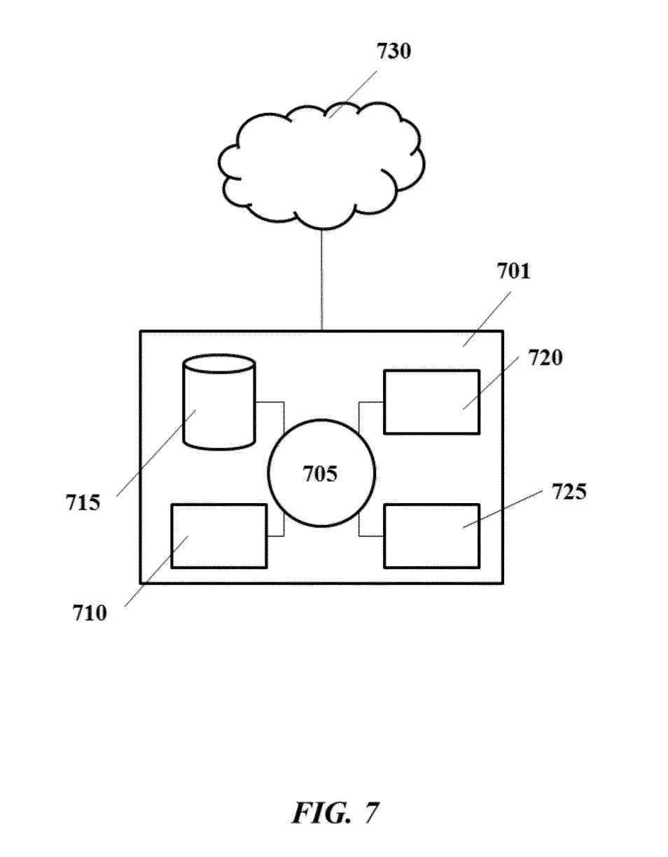

The present disclosure provides computer control systems that are programmed to implement methods of the disclosure. FIG. 7 shows a computer system 701 that is programmed or otherwise configured to facilitate a chat session and the exchange of queries and responses to the queries between users. The computer system 701 can regulate various aspects of chat sessions and queries of the present disclosure, such as, for example, enabling users to prepare queries, direct the queries to other users, and receive responses to the queries.

The computer system 701 includes a central processing unit (CPU, also “processor” and “computer processor” herein) 705, which can be a single core or multi core processor, or a plurality of processors for parallel processing. The computer system 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage and/or electronic display adapters. The memory 710, storage unit 715, interface 720 and peripheral devices 725 are in communication with the CPU 705 through a communication bus (solid lines), such as a motherboard. The storage unit 715 can be a data storage unit (or data repository) for storing data. The computer system 701 can be operatively coupled to a computer network (“network”) 730 with the aid of the communication interface 720. The network 730 can be the Internet, an internet and/or extranet, or an intranet and/or extranet that is in communication with the Internet. The network 730 in some cases is a telecommunication and/or data network. The network 730 can include one or more computer servers, which can enable distributed computing, such as cloud computing. The network 730, in some cases with the aid of the computer system 701, can implement a peer-to-peer network, which may enable devices coupled to the computer system 701 to behave as a client or a server.

The CPU 705 can execute a sequence of machine-readable instructions, which can be embodied in a program or software. The instructions may be stored in a memory location, such as the memory 710. Examples of operations performed by the CPU 705 can include fetch, decode, execute, and writeback.

The storage unit 715 can store files, such as drivers, libraries and saved programs. The storage unit 715 can store programs generated by users and recorded sessions, as well as output(s) associated with the programs. The storage unit 715 can store user data, e.g., user preferences and user programs. The computer system 701 in some cases can include one or more additional data storage units that are external to the computer system 701, such as located on a remote server that is in communication with the computer system 701 through an intranet or the Internet.

The computer system 701 can communicate with one or more remote computer systems through the network 730. For instance, the computer system 701 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 701 via the network 730.

Methods as described herein can be implemented by way of machine (e.g., computer processor) executable code stored on an electronic storage location of the computer system 701, such as, for example, on the memory 710 or electronic storage unit 715. The machine executable or machine readable code can be provided in the form of software. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 701 can include or be in communication with an electronic display that comprises a user interface (UI) for providing, for example, a chat session and facilitating the exchange of queries and responses to the queries between users. Examples of UI's include, without limitation, a graphical user interface (GUI) and web-based user interface.

### Examples

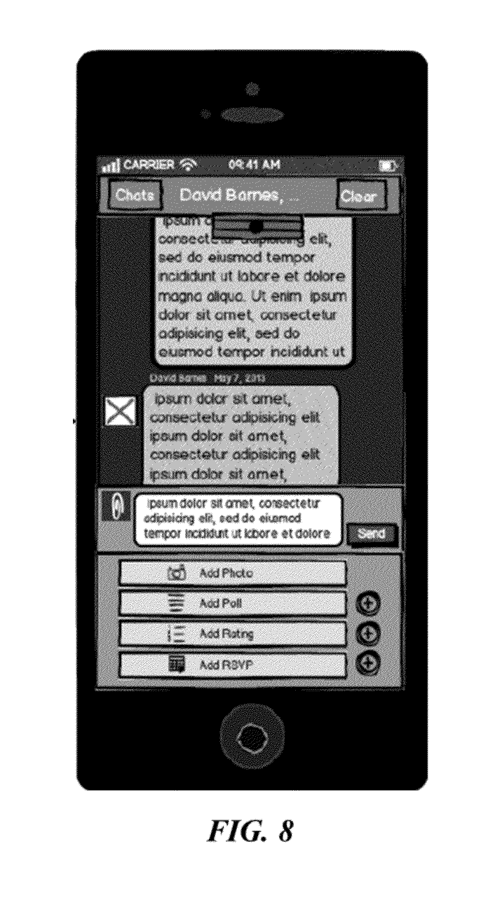

FIGS. 8-23 schematically illustrate a chat application that enables users to post queries and receive responses to the queries. The chat application can be implemented using a computer system that has a computer processor that is programmed to execute the application, such as a mobile electronic device with an electronic display.

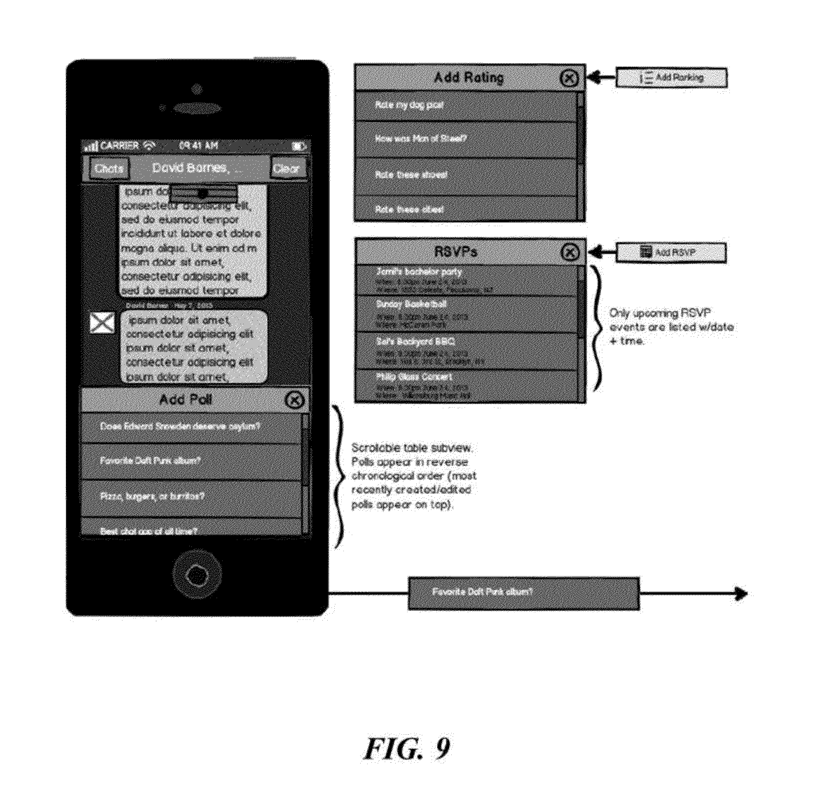

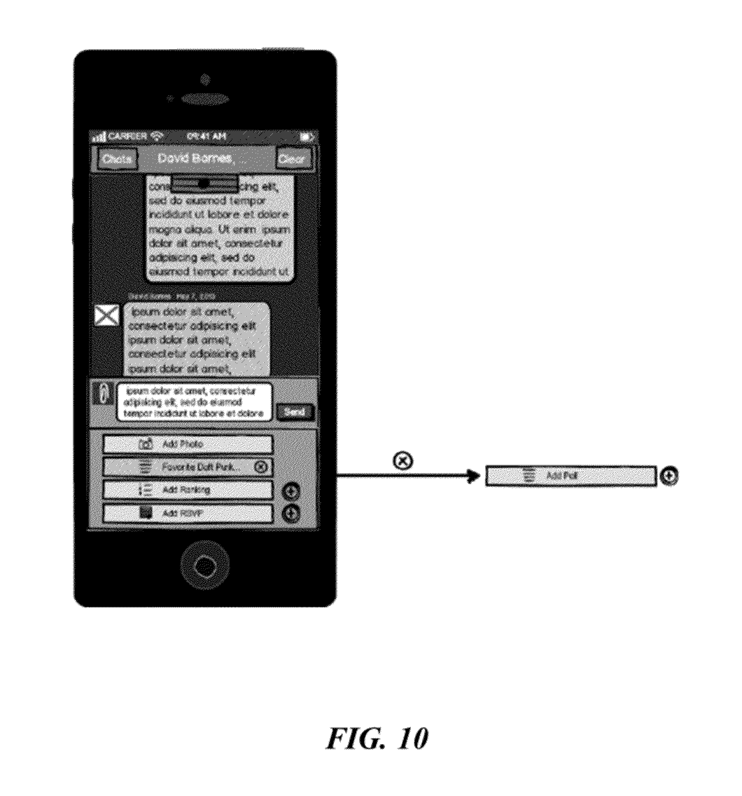

FIG. 8 shows a chat window having a chat between a first user and a second user. The chat window permits a user to input text as part of the chat. In FIG. 9, a user is permitted to submit a query in the chat window. In this example, the user elects to add a poll with a poll question selected from a list of previously created multiple questions. As an alternative, or in addition to, the user may also submit a rating query or a reservation request (or RSVP). The user may be provided with a list of queries to submit for a rating, or a list of events to submit to request a reservation. In FIG. 10, the user has selected to add “Favorite Daft Punk Album?” as a poll query. Polls that can be selected from may not be pre-loaded. In some cases, polls can be user created.

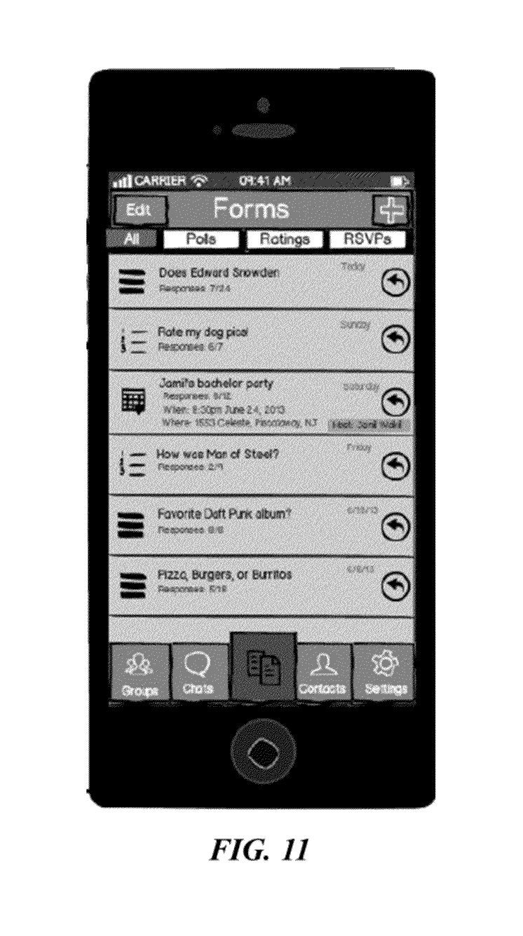

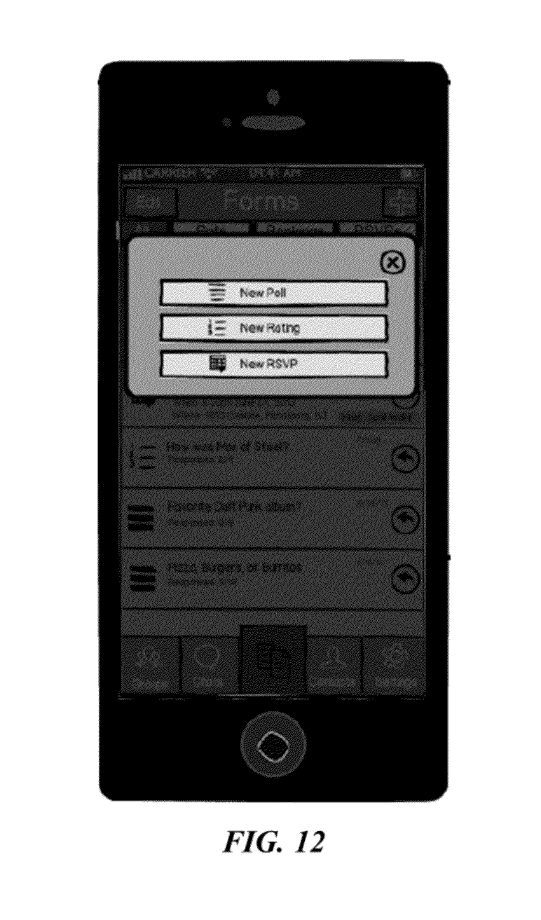

The chat application can enable the user to build user-defined form queries. In FIG. 11, the user is permitted to define poll, ratings and RSVP queries. For example, under RSVP queries, the user can input events that the user may wish to get reservations for. The user can select the “+” button to add queries as desired, as shown in FIG. 12.

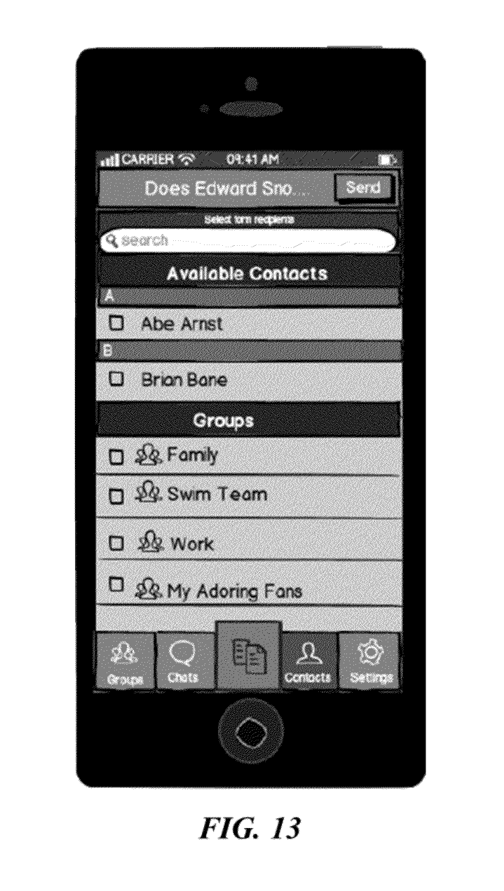

The user can create a new query and select which users to add to the query as recipients. In FIG. 13, the user builds a poll query and selects recipient users from list of contacts of the user.

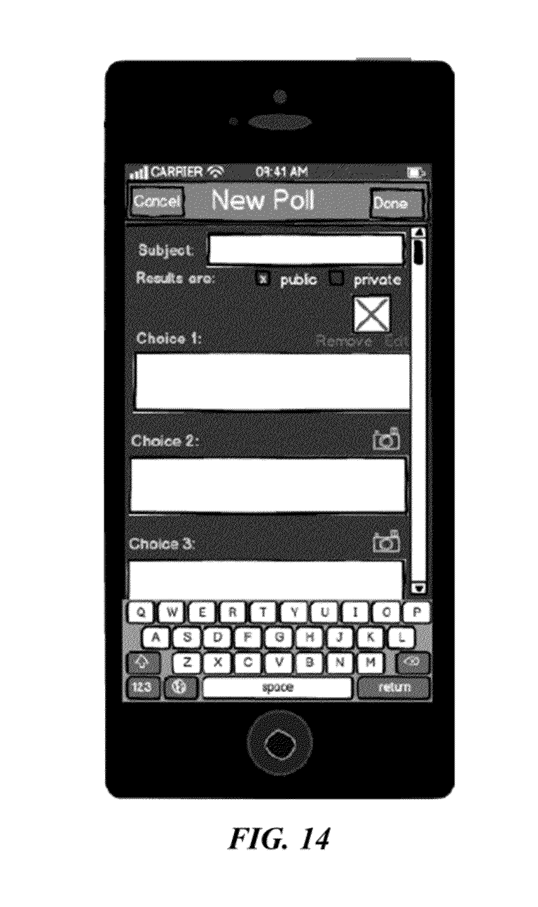

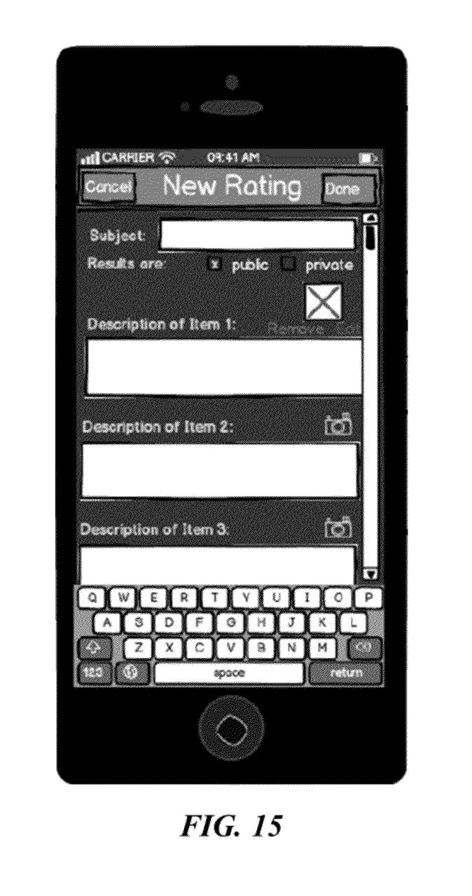

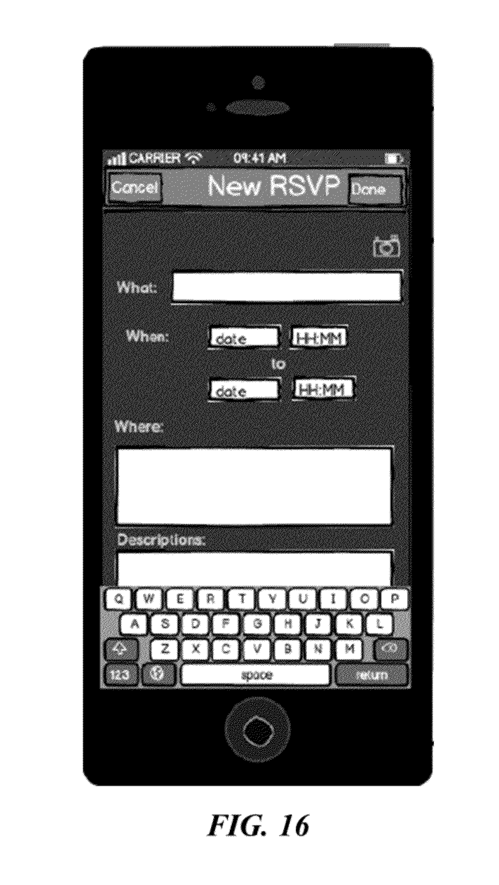

The application can permit a user to build a new query, such as a poll query, rating query and RSVP (or reservation) query. In FIG. 14, the user is able to build a new poll query and input various fields of the poll, such as subject, privacy (i.e., public or private), and choices for the poll, which may be choices that recipients of the poll will select from. In the illustrated example, three choices for the poll are shown, but the application can permit the user to have other numbers of choices, such as at least 2, 3, 4, 5, 6, 7, 8, 9, 10, or more choices. The user can include a picture or other media (e.g., audio or video) with each choice. In FIG. 15, the user is able to build a new rating query and input various fields of the rating, such as subject, privacy (i.e., public or private), and descriptions of items. While three descriptions are shown in FIG. 15, an application can permit a user to have other numbers of descriptions, such as at least 2, 3, 4, 5, 6, 7, 8, 9, 10, or more descriptions. Further, examples having only one option may be provided. The user can include a picture or other media (e.g., audio or video) with each description. In FIG. 16, the user is able to build a new RSVP query for an event, and input various fields of the query, such as a description of the event, date and time of the event, location of the event and a description of the event. The user can include a picture or other media (e.g., audio or video) to accompany the RSVP.

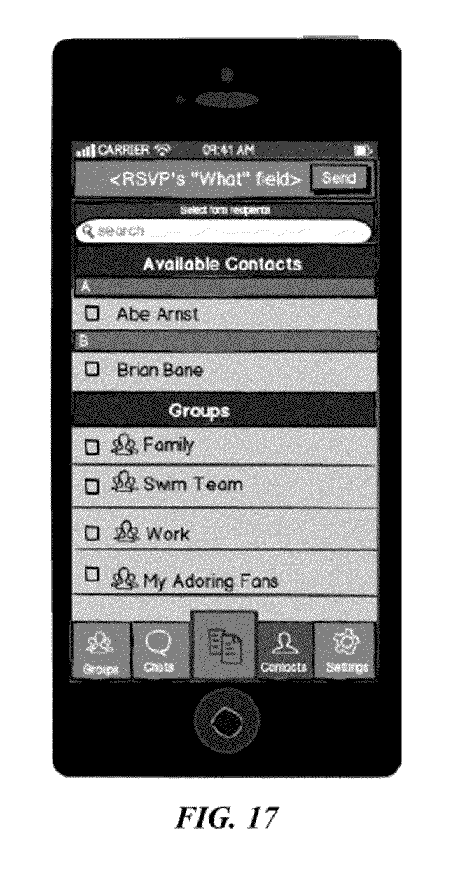

Each query can permit the user to include a list of recipients. In FIG. 17, in building a new RSVP query, the user is able to select a list of recipients for the RSVP. The list of recipients can be from a contact list of the user. As an alternative or in addition to, the user can input information of a recipient manually. In some cases, queries can be attached in the same or similar manor a picture from a camera roll can be attached directly through the chat.

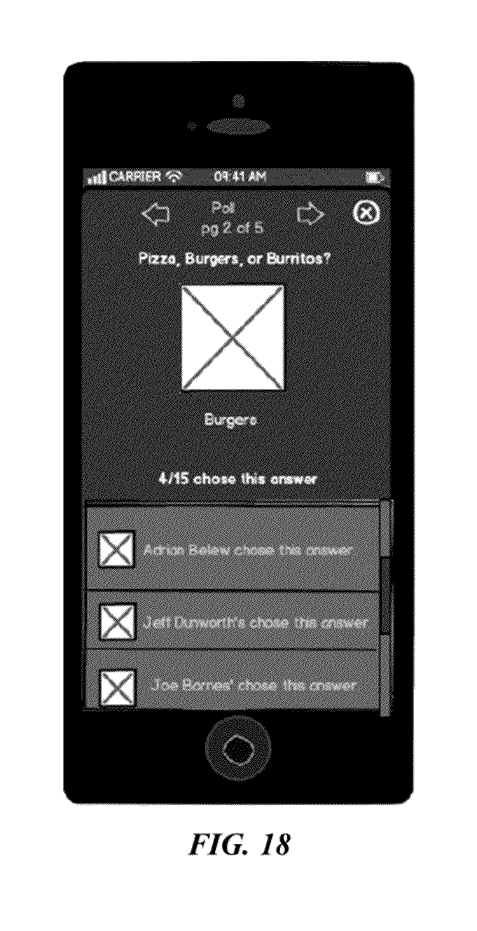

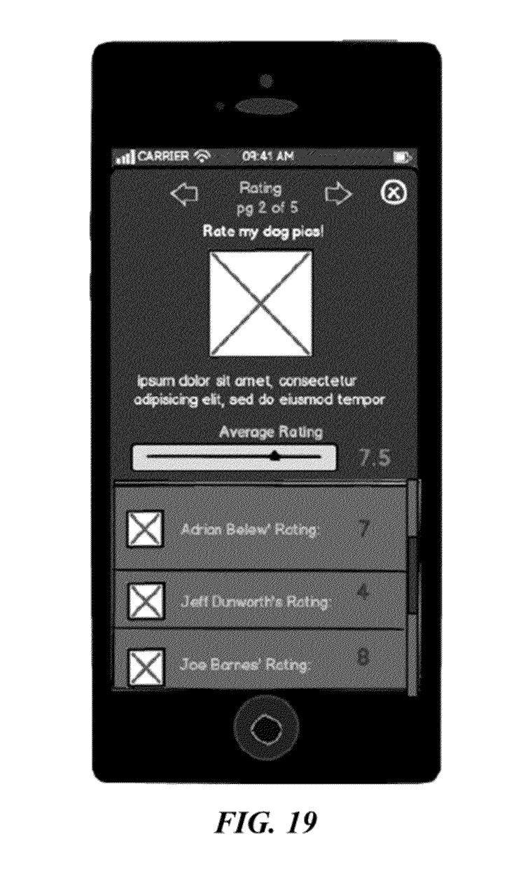

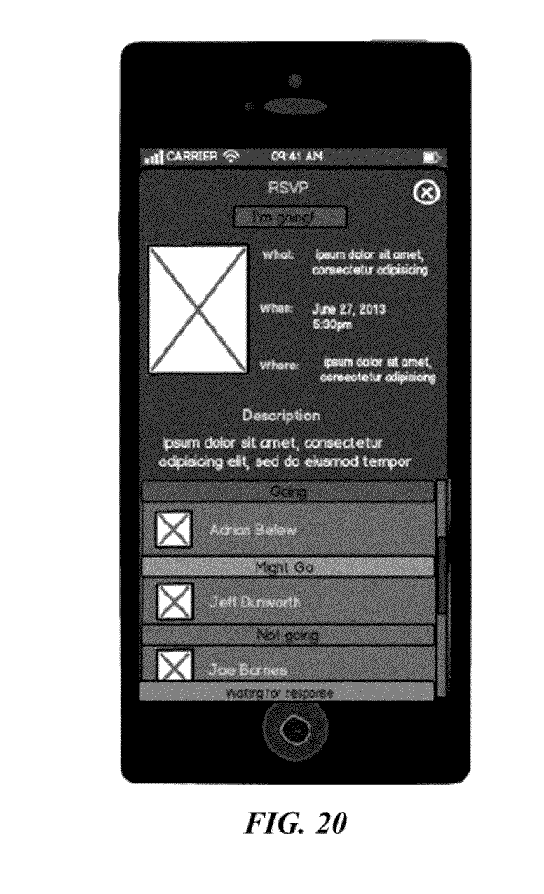

The application can present recipients with queries, such as polls, ratings and RSVP's. Each query can be accessible from a chat window of the application. In FIG. 18, a recipient user is able to scroll through multiple polls and select responses to each of the polls. In FIG. 19, the recipient user is able to scroll through multiple ratings and select responses to each of the ratings. The application shows the recipient user the selected ratings of other users and an average rating (“7.5”). In FIG. 20, the recipient user is able to make a reservation to a given event. The application shows the recipient user which other users have elected to attend to an event, not attend the event or indicate that they might go to the event.

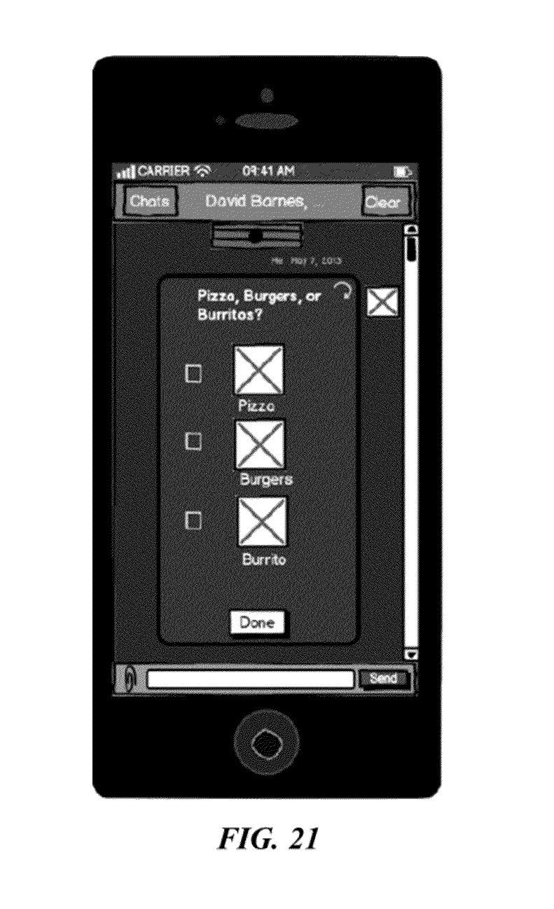

FIG. 21 is an example of a poll query in which the recipient user is given three choices to select from, namely “Pizza,” “Burgers,” and “Burrito.” The recipient user can make a selection and click on “Done,” and subsequently return to a chat with one or more other users, including the user that generated the poll.

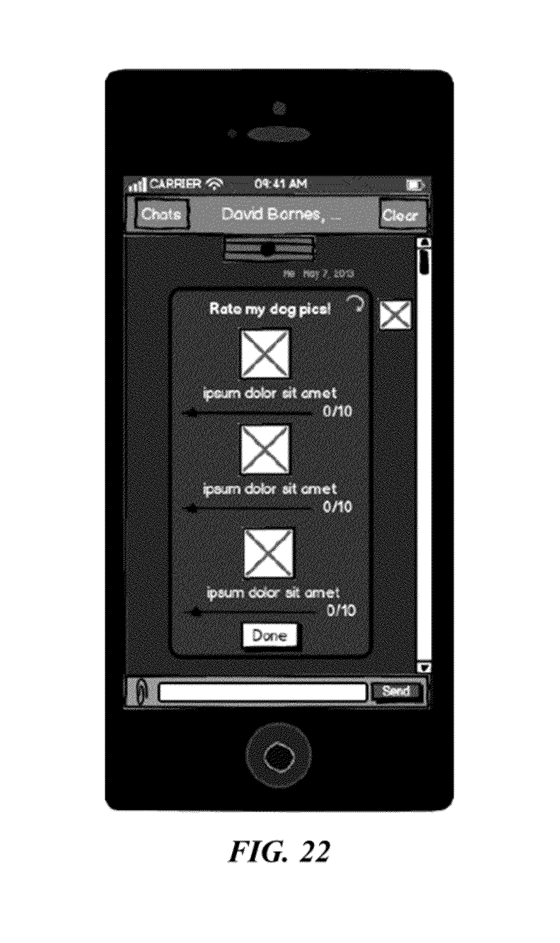

FIG. 22 is an example of a rating query in which the recipient user is given three pictures to rate on a 1-10 scale. The recipient user can rate one, two, or all three of the pictures, and subsequently return to a chat with one or more other users, including the user that generated the poll. In additional examples, a user may be presented with only one design.

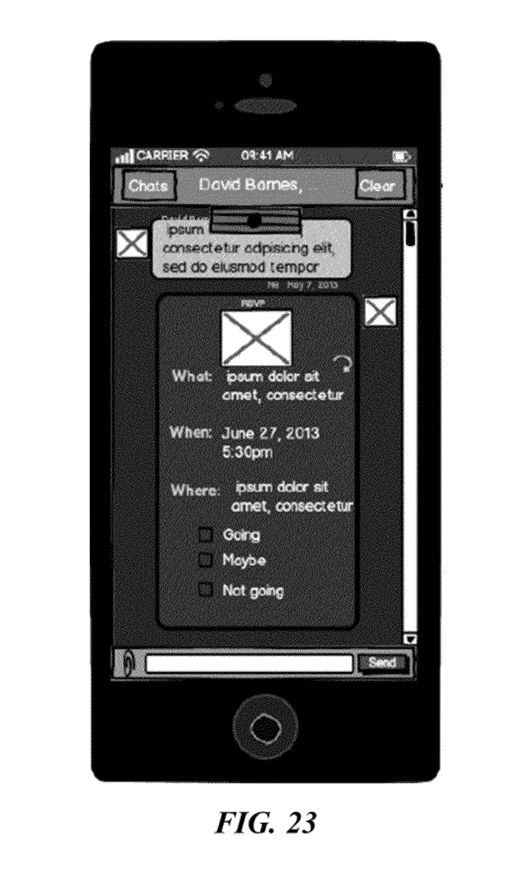

FIG. 23 is an example of an RSVP query in which the recipient user is given the opportunity to RSVP to an event. The recipient user is given three RSVP options to select from, namely “Going,” “Maybe” and “Not going.” The recipient user can make a selection and subsequently return to a chat with one or more other users, including the user that generated the poll.

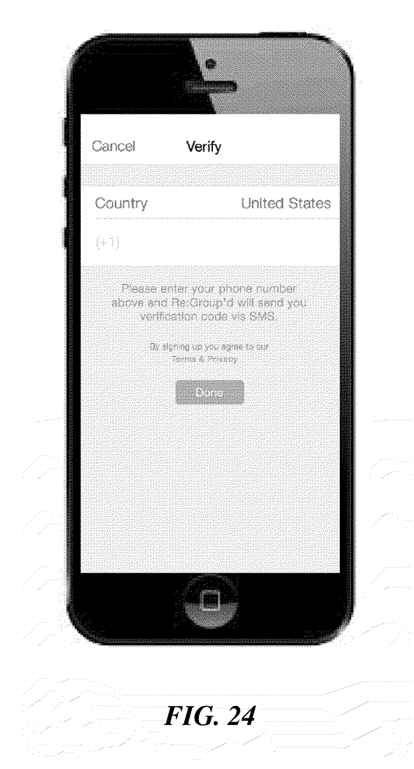

FIGS. 24-26 schematically illustrate a verification application that enables users to signup and login to a chat application. The verification application can be implemented using a computer system that has a computer processor that is programmed to execute the application, such as a mobile electronic device with an electronic display.

FIG. 24 shows a verification window where a user may input a phone number that may be associated with an account of a chat application. The verification window may be presented to a new user, such as a user who is first signing up to the chat application. Alternatively, the verification window may be presented to users who already have an account on the chat application. In some examples, a user may choose to engage in a verification application prior to each login to the chat application to ensure that the user's account data is protected.

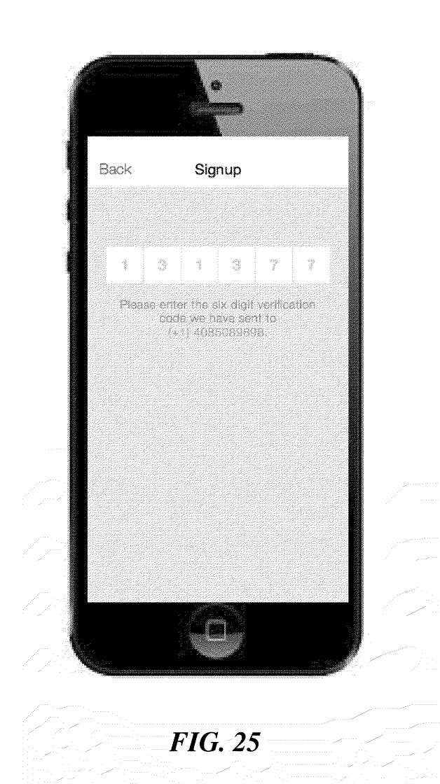

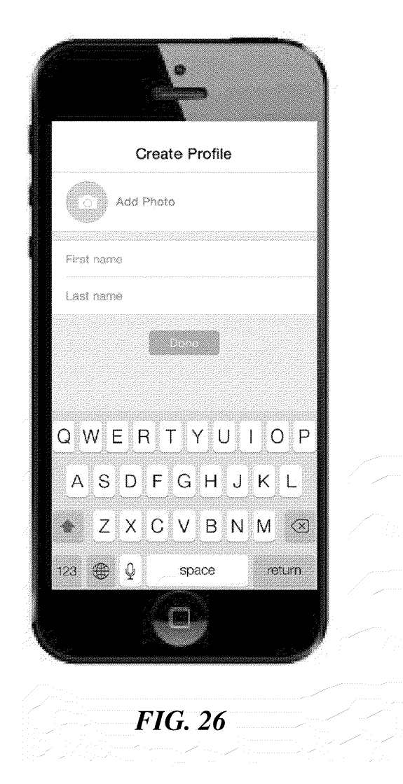

Once a user has entered a phone number that may be associated with an account of the chat application, the verification application may send a verification code to the phone number that is entered. As illustrated at FIG. 25, the user may input the verification code into a subsequent step of a verification application. While FIG. 25 illustrates inputting a verification code as part of signing up for an account, this additional authentication step may also be provided when a user already has an account with the chat application. Once the user has entered the verification code, the user may be presented with a screen that allows the user to create a profile as seen in FIG. 26.

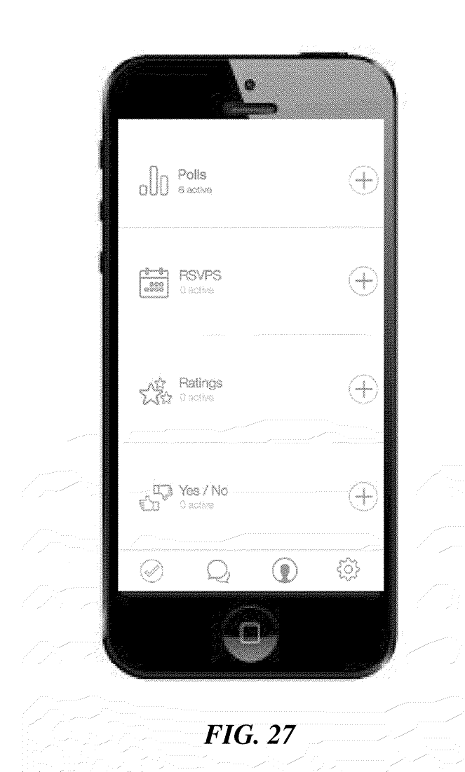

FIGS. 27-52 show screen shots that illustrate further aspects of a chat application. Similar to FIGS. 8-23, the chat application can be implemented using a computer system that has a computer processor that is programmed to execute the application, such as a mobile electronic device with an electronic display.

FIGS. 27-30 show screen shots that illustrate aspects of a chat application. In particular, FIGS. 27-30 show examples of home screen and basic messaging aspects. In particular, FIG. 27 illustrates a mobile device having a home screen that shows four aspects of the chat application, namely: a polling aspect, an RSVP aspect, a ratings aspect, and a Yes/No aspect. These aspects will be discussed further herein.

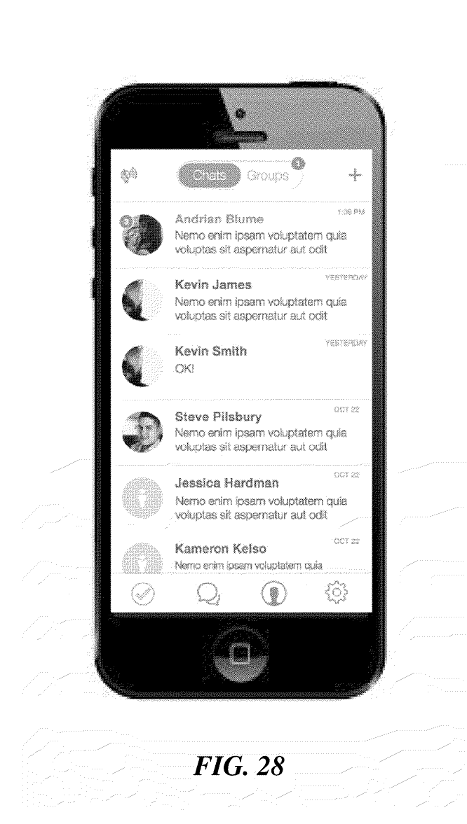

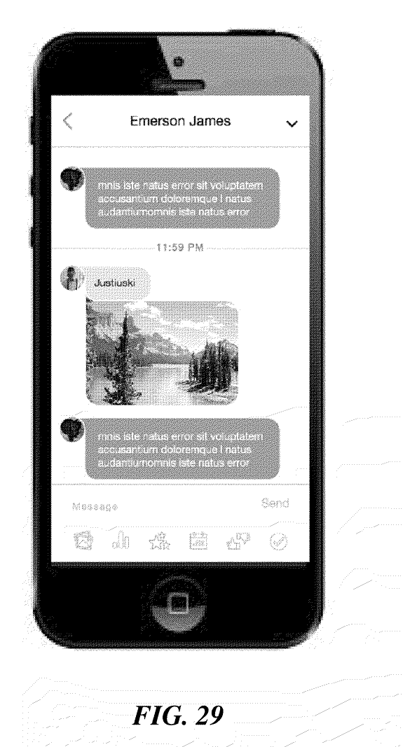

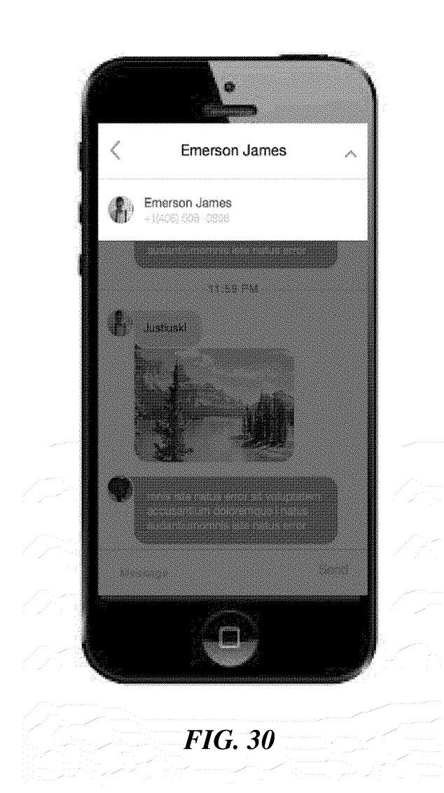

FIG. 28 shows an example of basic messaging features of the chat application. In particular, FIG. 28 shows a mobile device that is displaying a list of current chats with individual users. The selection of the “Chats” option at the top of the screen may allow the user to focus on individual chats, whereas selecting the “Groups” option at the top of the screen may allow the user to focus on group chats. Additionally, FIG. 29 shows an individual chat between a user and a contact, “Emerson James,” using the chat application. As seen in FIG. 29, both text and images may be presented in the chat application. The user may also use the chat application to display the contact information of “Emerson James” by engaging the top portion of the screen shot presented, as seen in FIG. 30. After engaging the top portion of the screen shot listing the name of the contact “Emerson James,” the phone number of the contact may be presented.

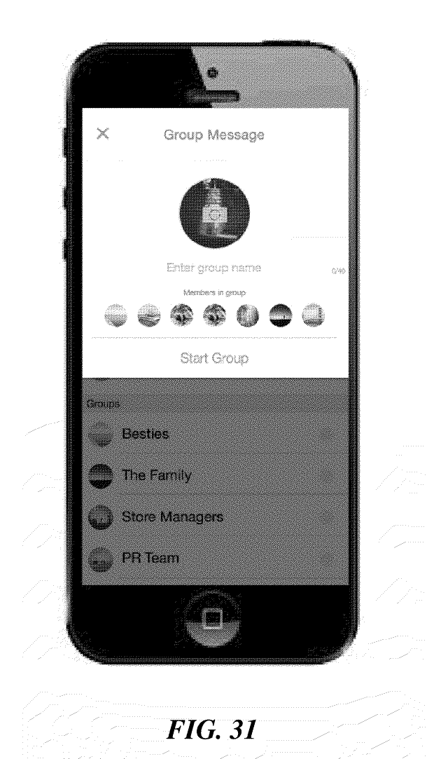

FIGS. 31-37 show screen shots that illustrate group aspects of a chat application. In particular, FIG. 31 shows a group message window. The group message window allows the user to enter a group name and allows the user to start the group by engaging a “start group” indicator. Additionally, the group message window provides images associated with group members within the potential group. These images may be associated with profiles of the individual group members.

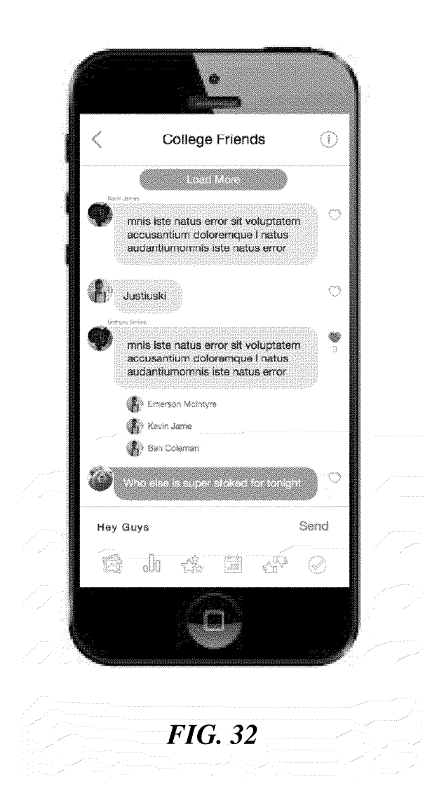

Once a user has started the group, the user may interact with individuals in the group using a group chat window. FIG. 32 illustrates a group chat window with a group called “College Friends.” As seen in FIG. 32, messages from group members may be displayed on a mobile device of the user. The user may indicate that he “likes” particular messages presented in the group chat window. In particular, the user may engage a heart-shaped icon to indicate that he likes a message from Bethany Smiles. Additionally, the user may input messages to provide to individuals in the “College Friends” group, such as “Hey Guys” before confirming the message by pressing the “Send” button. Alternatively, the user may set their group chat window to provide messages to the group chat window as the messages are being written, without the need to engage an additional “Send” button.

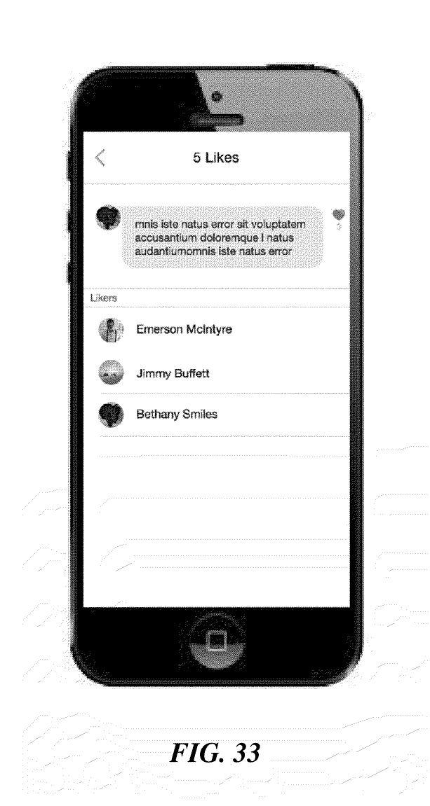

In addition to “like”-ing a message provided to a group text, the user may also be presented with a number of other users who “like” a message, either of the user or of another individual in the group. As seen in FIG. 33, a user may see a message provided to the group and may see the total number of likes (5), the number of likes by individuals in the group of the user (3), and a listing of the individuals in the group of the user that “like” the message (Emerson McIntyre, Jimmy Buffett, and Bethany Smiles). If there are more total “likes” than group members indicated, some members of the group may have hidden their association with their “like.”

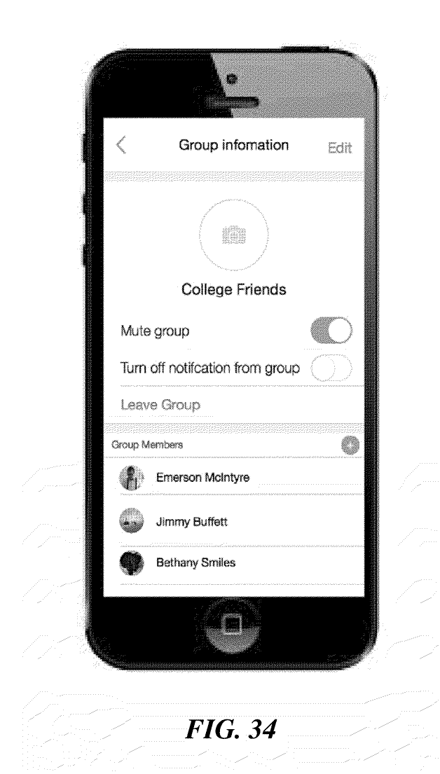

Additionally, FIG. 34 provides information related to a group. In particular, FIG. 34 provides information related to the group “College Friends,” such as options to “Mute group,” “Turn off notification from group,” Leave Group,” and add group members as indicated by a “+”. The “Mute group” and “Turn off notification from group” options may be turned on or off based on the user's preference. Additionally, a list of group members may be presented to the user so that the user is aware of individuals that may need to be added.

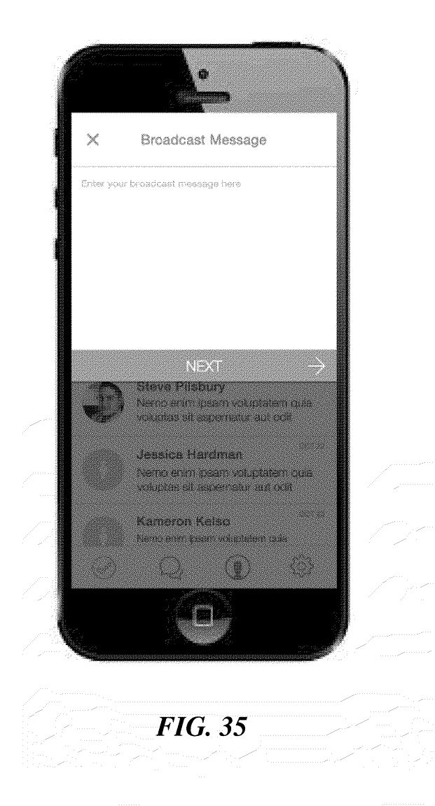

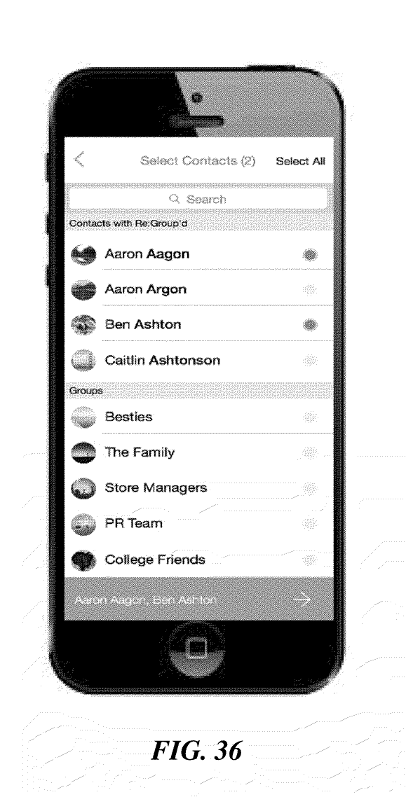

In addition to editing group information, a user may also broadcast a message to a group, as shown in FIG. 35. In particular, a user may input a message to be broadcast in the “Broadcast message” area presented on the user's device. After entering a message, the user may select “Next” and may select contacts to receive the broadcast message. For example, the user can select contacts from a list of contacts indicated in FIG. 36.

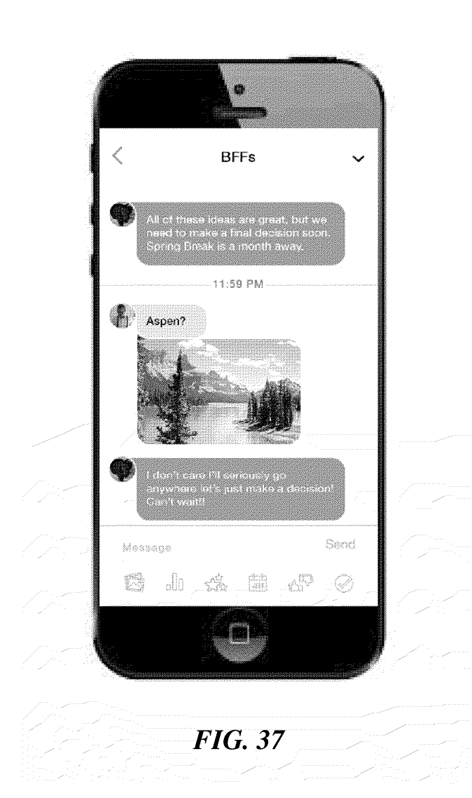

As shown in FIG. 36, a user may select contacts by engaging an indicating circle to the name of each contact. The names of the selected contacts may be provided at a bottom portion of the screen of the mobile device. Additionally or alternatively, the number of contacts selected may be provided at the top portion of the screen of the mobile device. Once the contacts are selected, a message may be broadcast as shown in FIG. 37.

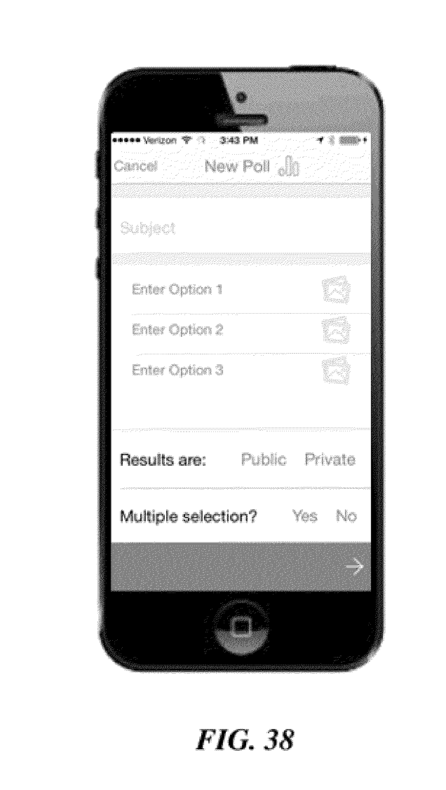

FIGS. 38-41 show screen shots that illustrate polling aspects of a chat application. In particular, FIG. 38 shows a template for a new poll. The template includes an input for a “Poll subject” as well as an input for three options (“Option 1”, “Option 2”, “Option 3”). Additionally, the template allows for results to be made “Public” or “Private,” and allow a user to design the poll so as to allow an individual to select more than one polling option.

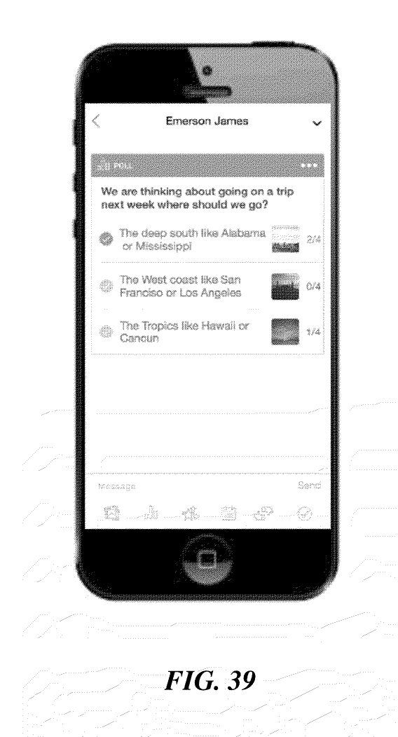

An example of a poll is presented in FIG. 39. In particular, the poll question states, “We are thinking about going on a trip next week where should we go?” As see in FIG. 39, three options are given of the deep south, the west coast, or the tropics. Additionally, the poll has associated images with each of the choices. In this way, the user may use the associated images as a factor for deciding between the polling choices. Further, the polling choices may be presented along with a current vote associated with the polling options. This is illustrated in FIG. 39 which shows 2/4 users polled have indicated a preference for a trip to the deep south, 0/4 users have indicated a preference for a trip to the west coast, and 1/4 users have indicated a preference for a trip to the tropics.

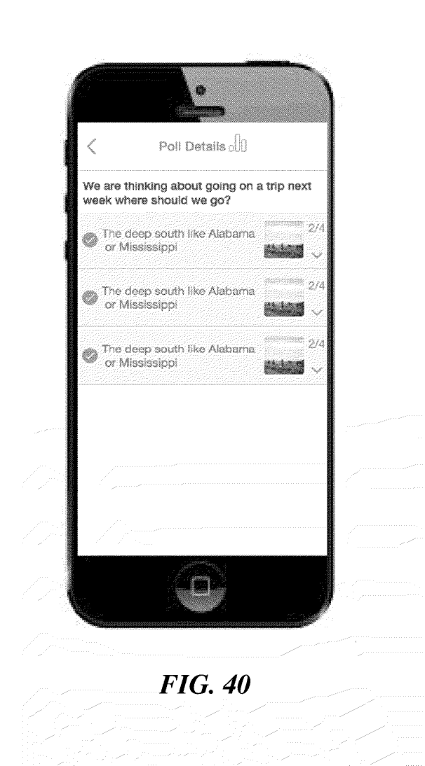

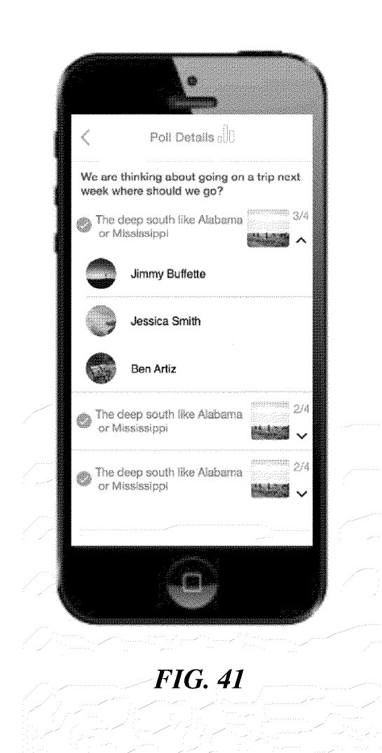

While some polls may be designed to accept only one answer, other polls may be designed to allow users to indicate more than one option. However, if users are allowed to enter more than one preference, there may be ties as seen in FIG. 40. In particular, each trip option shown in FIG. 40 has 2/4 votes selected. Since there are only 4 users, and six votes have been recorded, at least two other users have selected more than one trip option. In order to make more informed choices, however, the poll may provide the option to see the individual users who have made the individual selections. This is illustrated in FIG. 41, which shows an expanded trip option of visiting the deep south. In particular, a user may expand a trip option that 3/4 individuals have selected to see that the three individuals who have selected that options are Jimmy Buffette, Jessica Smith, and Ben Artiz.

FIGS. 42-45 show screen shots that illustrate rating aspects of a chat application. In particular, FIG. 42 shows a new rating template where a user has provided an image to be assessed by other individuals. FIG. 42 includes a subject input, as well as an option of having rating results that are “Public” or “Private.”

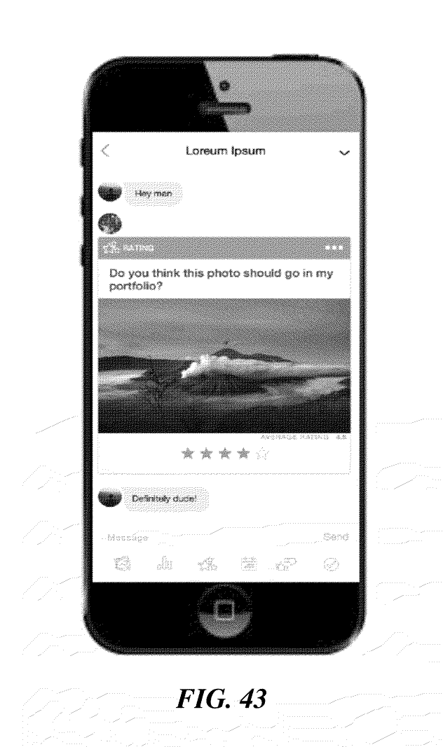

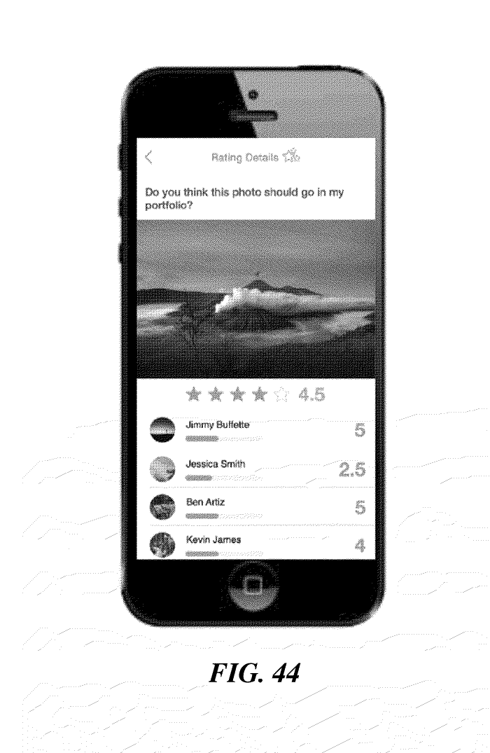

An example of a rating that is presented to a user is shown in FIG. 43. In particular, FIG. 43 shows an image that is presented on the screen of a mobile device with the ratings question, “Do you think this photo should go in my portfolio?” with a star-based rating showing 4 of 5 stars highlighted. The presentation also allows the user to input a message related to the ratings question. Additionally, a user may look up ratings details as shown in FIG. 44. In particular, FIG. 44 shows the rating image, the rating question, the overall rating, and a list of users who provided ratings. The list of users who have provided ratings are each associated with their individual rating. For example, Jimmy Buffette is associated with providing a rating of 5 and Jessica Smith is associated with providing a rating of 2.5.

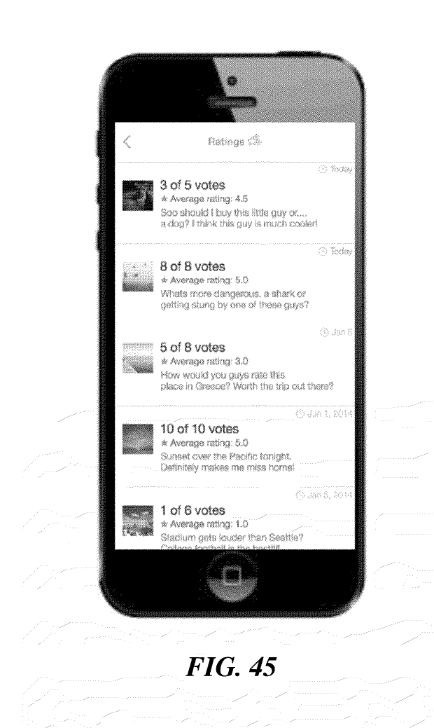

A user may also review multiple ratings on the screen of the mobile device. As seen in FIG. 45, the user may review a series of five ratings. Each rating presented may include the ratings image, the ratings question, a number of votes that were received from inquiries, an average rating based on the votes received, and a date on which the rating question was initiated. For example, FIG. 45 shows a rating of the image and question relating to Greece, which states, “How would you guys rate this place in Greece? Worth the trip out there?” In this example, 5 out of 8 individuals voted, providing an average rating of 3.0. Average ratings may be determined based on the mean, median, or mode of the ratings received.

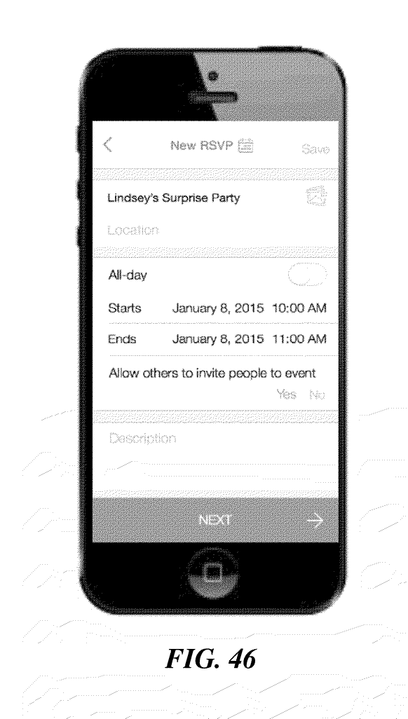

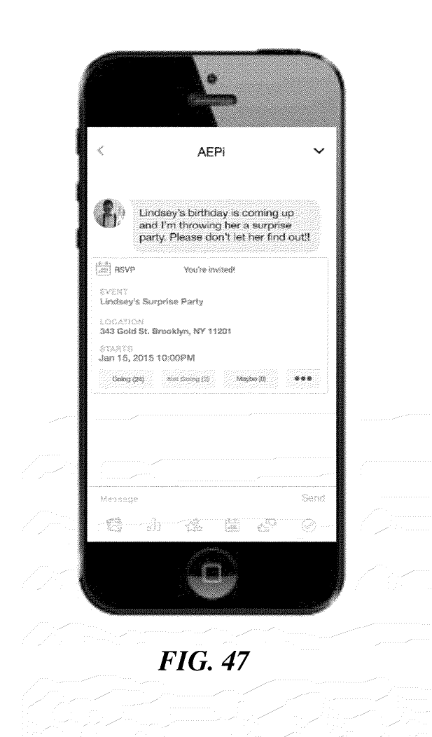

FIGS. 46-48 show screen shots that illustrate RSVP aspects of a chat application. In particular, FIG. 46 provides an RSVP template that may be presented on the screen of a mobile device. As seen in FIG. 46, the user may input an event subject, “Lindsey's Surprise Party”, a location, an indication of whether it is an all-day event, a start/end time if it is not an all-day event, an indication of whether guests are allowed to invite other people to the event, and a description of the event. An example of a completed RSVP request is shown in FIG. 47. In particular, the completed RSVP has the message, “Lindsey's birthday is coming up and I'm throwing her a surprise party. Please don't let her find out!!”

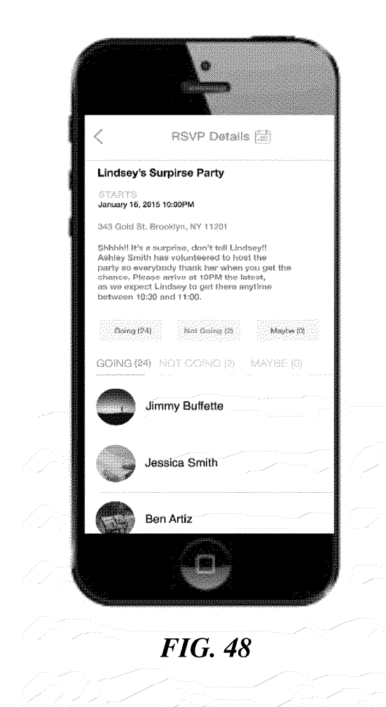

Additionally, the RSVP has a banner indicating to the user, “You're invited!” and provides details input by the RSVP event organizer, such as the event subject, “Lindsey's Surprise Party,” the location, “343 Gold St. Brooklyn, N.Y. 11201,” and the start time, “Jan. 15, 2015 10:00 PM.” When a user is presented with an RSVP event, the user may indicate that he is “Going,” “Not Going,” or “Maybe.” Additionally, the number of other users who have selected these indicators may be provided with the option choices. Further, as seen in FIG. 48, a user may highlight option choices to view a list of other users who are listed under their respective option choices. For instance, the user may select the “Going” option and may then be provided with a list of users who are going to the event.

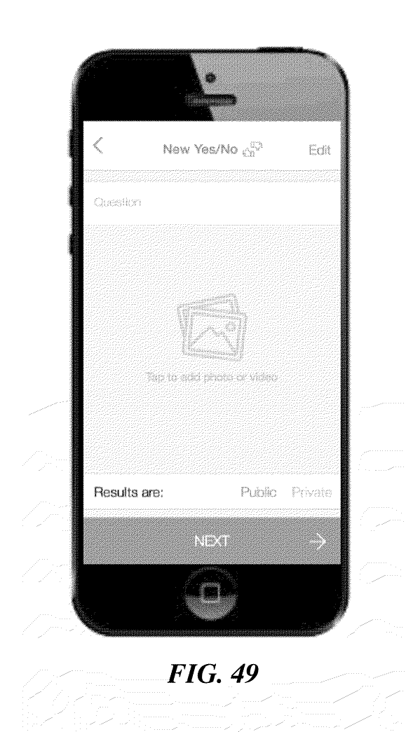

FIGS. 49-52 show screen shots that illustrate Yes/No aspects of a chat application. In particular, FIG. 49 provides a Yes/No template that allows a user to input a photo or video that may be assessed by other individuals. FIG. 49 also includes a question input, as well as an option of having Yes/No results that are “Public” or “Private.”

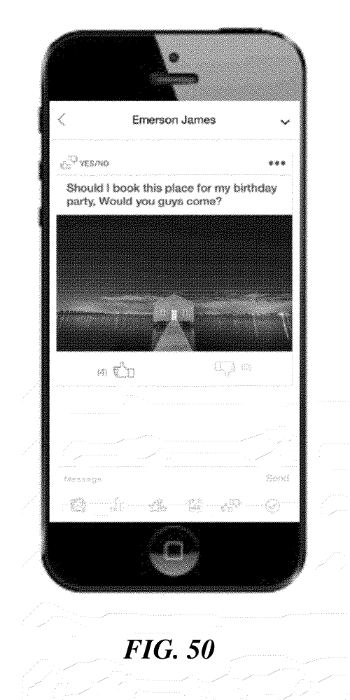

An example of a Yes/No question that is presented to a user is shown in FIG. 50. In particular, FIG. 50 shows an image that is presented on the screen of a mobile device with the Yes/No question, “Should I book this place for my birthday party, Would you guys come?” with a thumbs-up icon highlighted and a thumbs-down icon. The Yes/No question also allows the user to provide comments to the presentation of the Yes/No question.

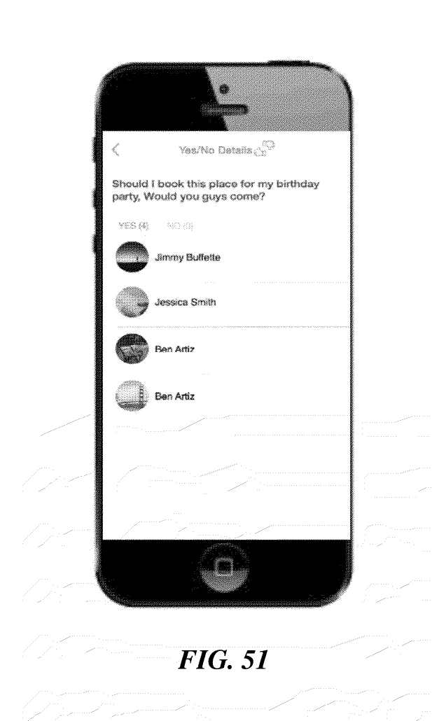

Additionally, Yes/No details may be provided in different examples. As seen in FIG. 51, Yes/No details may illustrate the question presented along with an indication of the number of “Yes” answers highlighted. The number of “Yes” answers may also have a listing of individuals who have chosen “Yes.” Although the “No” listing is not highlighted, a user may also choose to select the “No” listing to see the individuals who selected “No.” However, an indicator shown in FIG. 51 illustrates that the current number of “No” selections are zero.

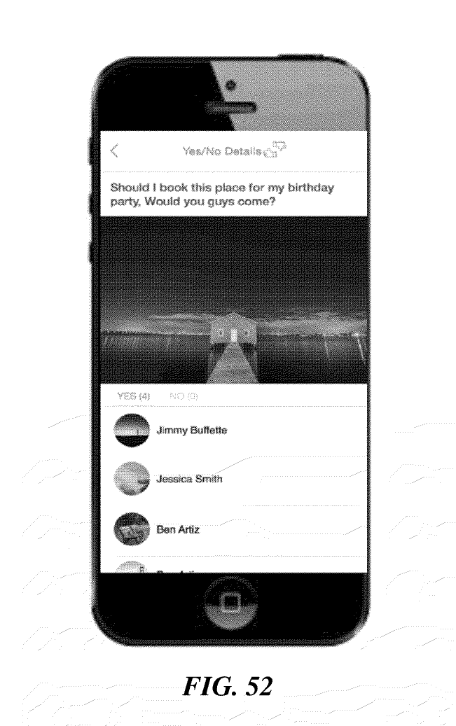

In another example, as seen in FIG. 52, Yes/No details may illustrate the question presented, the image presented, and an indication of the number of “Yes” answers highlighted. Similar to FIG. 51, the number of “Yes” answers may also have a listing of individuals who have chosen “Yes.” Similarly, a user may select the “No” listing to see the individuals who selected “No,” though as provided in FIG. 52 there are currently zero individuals who have selected “No.”

In addition to the interactive features discussed above, a query blast feature may be provided that allows users to interact with their favorite brands, teams, celebrities, or other entities. In examples, the query blast feature may allow users to easily engage and respond to feedback-driven posts from entities. In current systems, an entity such as Starbucks may poll users as to which flavor to introduce as a new latte: Peppermint Vanilla, Chai Mocha, or Cinnamon Spice. While the poll may allow the users to respond with a selection of one or more of the three options listed, it is currently not easy for an entity such as Starbucks to receive feedback on the selection of choices themselves. If a user has a comment on the poll choices themselves, he or she may be able to leave a comment in a general comment feed that is associated with Starbucks, but that option may require a laborious amount of work on the part of Starbucks to read, track, and respond to comments on a comment feed. In contrast, the query blast feature allows user to interact directly with their favorite brands, teams, celebrities, or other entity.

The interactions may occur through a curator that is associated with a brand, team, celebrity, or other entity. In examples where the entity is an individual, a curator of the entity may be the individual himself or herself. These interactions may occur in a messaging stream that may be similar to messaging streams disclosed herein. Alternatively, these messaging streams may include other aspects that allow and/or augment interaction between a user and a curator. In examples, users may interact directly with curators by voting on polls, inputting ratings on a scale (e.g., five stars), providing an answer to a yes-or-no question, or RSVP′ing to a curated event, such as a brand-curated event or a celebrity-curated event.

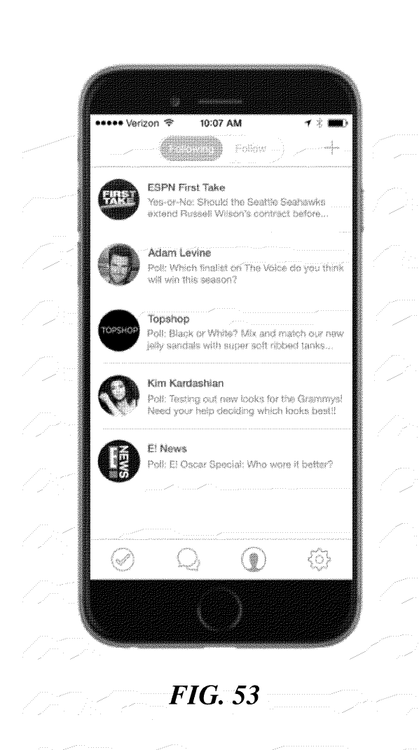

FIGS. 53-56 schematically illustrate a query blast feature application that enables users to interact with curators associated with desired entities. The query blast feature application can be implemented using a computer system that has a computer processor that is programmed to execute the application, such as a mobile electronic device with an electronic display.

In order to use the query blast feature application, users may first choose to follow an entity. After the user has begun to follow an entity, a curator associated with the entity may begin to interact directly with the user, such as providing content directly to the user. In examples, a user may search and select an entity to follow; a user may pre-select entities that may be suggested to the user; or the user may be presented with a potential entity and may then respond whether or not to follow the entity. An example of entities that a user follows is seen in FIG. 53 which shows an image that is presented on the screen of a mobile device. In particular, as seen in FIG. 53, the user is following the entities ESPN First Take; Adam Levine; Topshop; Kim Kardashian; and E! News. Once a user has selected at least one entity to follow, and been introduced to the curator associated with the entity, the user can participate in feedback-driven questions and may see votes update in real-time. Additionally or alternatively, the user may receive perks, promotional codes, or discount codes for participating in interactions with the curator. In this way, users may feel involved in decision-making and event planning associated with the entity.

Additionally, curators may also benefit from interactions with users using the query blast feature. In particular, using the query blast feature, curators may have the ability to connect with users on a personal level. The curators can also use the feedback from users to influence key decisions associated with the curator's entity. Using the Starbucks example above, fans may provide insight into the selection of potential latte flavors, and may suggest to curators of Starbucks that a fourth alternative such as Cinnamon Vanilla may be liked by fans more than, say, the current three options of Peppermint Vanilla, Chai Mocha, or Cinnamon Spice. Based on this feedback, Starbucks may alter their poll of new flavors to add a fourth option and/or delete a previous option that was proposed. In addition to using user participation to help Starbucks in making this decision, Starbucks may also use the query blast feature to allow additional user engagement, encouragement, and participation in other events associated with the curator of Starbucks. In particular, the curator may generate networks associated with particular groups of users so as to engage with the users in a more specified manner. For example, Starbucks may target a group of users in a particular area to attend a local promotion event. Additionally, by utilizing the query blast feature, which includes any combination of polls, ratings, RSVPs, Yes/Nos and text that is all interactable, the curators of desired entities may improve their ability to receive and track feedback that is associated with a group of users.

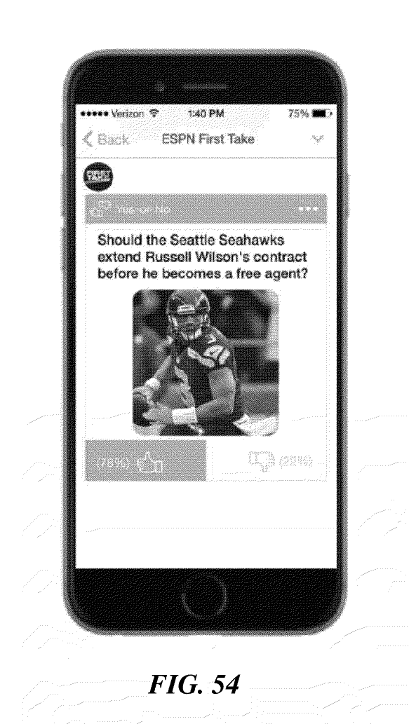

Examples of interactions between users and curators are found in FIGS. 54-56. In particular, FIG. 54 shows a yes-or-no question presented from a curator of First Take to a user. The yes-or-no question is presented in a mobile messaging format, and asks the user to answer, “Should the Seattle Seahawks extend Russell Wilson's contract before he becomes a free agent?” The user may select “Yes” or “No” and the user may see interactive results from the poll. In particular, the user may see how many people are voting “Yes” or “No” as the poll progresses.

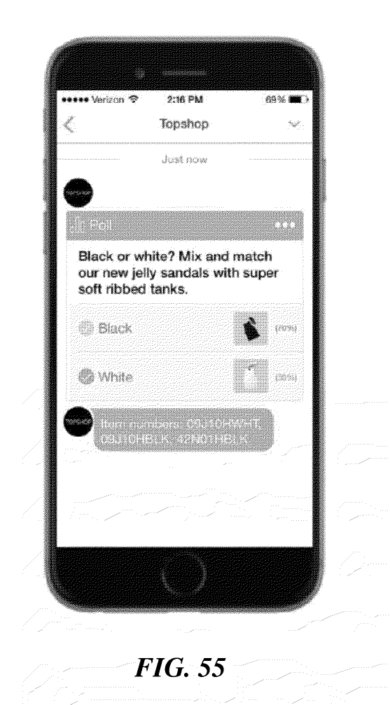

In another example of the query blast feature, a curator of Topshop has provided a poll directly to a user, as seen in FIG. 55. In particular, Topshop is asking the question, “Black or white? Mix and match our new jelly sandals with super soft ribbed tanks” In response, the user may select “Black,” “White,” or both. Additionally, the Topshop curator has provided the item numbers of the jelly sandals and tanks so that the user can follow up with the store directly. In this way, the curator of Topshop may interact with the user directly, and the user may respond directly. In other examples, the user may respond with a message directly to the curator, e.g., to comment on the choices that have been provided. For example, the user may suggest to Topshop that red jelly sandals would be more desirable than black or white sandals. The user can then receive promotions, discounts, or make purchases directly from this account.

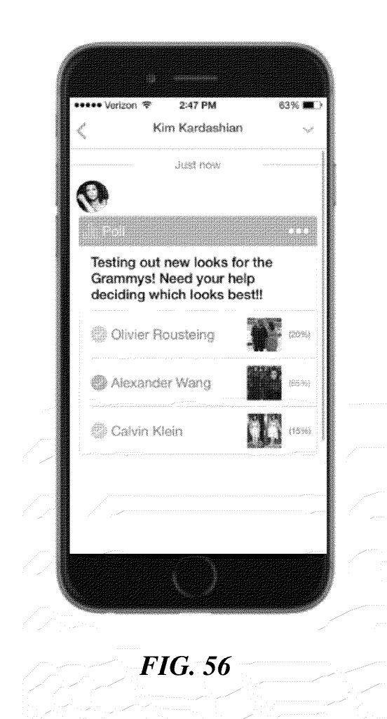

In an example involving an entity that is an individual, Kim Kardashian may provide a poll directly to her fans as seen in FIG. 56. In examples, Kim may either interact with her fans directly (e.g. as her own curator) or Kim may interact with her fans through a curator, such as a personal assistant. As seen in FIG. 56, Kim is asking the user to respond by choosing a designer for her upcoming Grammys outfit. The user may respond directly to Kim, or Kim's curator, by selecting a designer of the choices given. Alternatively, the user may provide a message in response that indicates Kim should wear a dress designed by Vera Wang instead. In this way, the users receiving the curator's interactions may feel that they are influencing Kim's decisions, and Kim may receive direct feedback from users.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for real time polling, rating, or requesting reservations to events, comprising:
(a) receiving, on a mobile electronic device of a first user, a query from an electronic device of a second user, wherein said query is a polling query, rating query, or a request for a reservation to a given event;
(b) presenting said query on a user interface (UI) of a chat application on the mobile electronic device of the first user;
(c) receiving, on said UI, a response to said query from said first user; and
(d) transmitting said response from said mobile electronic device of said first user to said electronic device of said second user, wherein said response is displayed on a user interface of said electronic device of said second user.

2. The method of claim 1, wherein said chat application displays a chat between said first user and said second user.

3. The method of claim 1, wherein said response is displayed on said user interface of a chat application executed on said electronic device of said second user.

4. The method of claim 1, wherein said event is a social event, recreational event, educational event, or work event.

5. The method of claim 1, wherein said query is received in the form of an electronic message.

6. The method of claim 5, wherein said electronic message is a short message service (SMS) text message or a multimedia messaging service (MMS) text message.

7. The method of claim 5, wherein said electronic message is an electronic mail.

8. A method for real time polling, rating, or requesting reservations to events, comprising:
(a) directing a query from an electronic device of a user to a mobile electronic device of each of one or more other users, wherein said query is a polling query, rating query, or a request for a reservation to a given event;
(b) receiving one or more responses to said query from at least a subset of said one or more other users;
(c) generating a report from said one or more responses on said electronic device of said user; and
(d) displaying said report on a user interface of said electronic device of said user.

9. The method of claim 8, wherein said report is displayed in a chat application on said electronic device of said user.

10. The method of claim 9, wherein said chat application includes a chat between said user and at least some of said other users.

11. The method of claim 8, wherein said event is a social event, recreational event, educational event, or work event.

12. The method of claim 8, wherein said query is directed in the form of an electronic message.

13. The method of claim 12, wherein said electronic message is a short message service (SMS) text message or a multimedia messaging service (MMS) text message.

14. The method of claim 12, wherein said electronic message is an electronic mail.
